(19) United States
(12) Patent Application Publication
(10) Pub. No.: US 2025/0276371 A1
(43) Pub. Date: Sep. 4, 2025

(54) ALIGNMENT MONITORING AND CONTROL

(71) Applicants: Rolls-Royce Corporation, Indianapolis, IN (US); Rolls-Royce plc, London (GB)

(72) Inventors: Scott Nelson, Indianapolis, IN (US); David James Puhl, Indianapolis, IN (US); Clive Grafton-Reed, London (GB); Peter E. Daum, Indianapolis, IN (US); Robert F. Proctor, Indianapolis, IN (US); Christopher Paul Heason, London (GB)

(21) Appl. No.: 18/593,538

(22) Filed: Mar. 1, 2024

(51) Int. Cl. B22F 10/37; B22F 10/28; B22F 12/90; B23K 26/342; B33Y 10/00; B33Y 30/00; B33Y 50/02

(52) U.S. Cl. CPC B22F 10/37; B22F 10/28; B22F 12/90; B23K 26/342; B33Y 10/00; B33Y 30/00; B33Y 50/02

(57) ABSTRACT

An additive manufacturing system includes an energy delivery device configured to deliver energy to a build surface of an additively-manufactured component to form a melt pool and a powder delivery device configured to direct a powder stream toward the melt pool. The system further includes a powder flow monitoring system configured to observe the powder stream and an optical system configured to observe the melt pool. A computing device configured to receive data indicative of a position of the powder stream, and receive data indicative of a position of the melt pool. The computing device is configured to determine a relative position of the powder stream to the melt pool and control, based on the determined relative position of the powder stream to the melt pool, one or both of the powder delivery device and the energy delivery device.

### TECHNICAL FIELD

The disclosure relates to additive manufacturing techniques.

### BACKGROUND

Additive manufacturing generates three-dimensional structures through addition of material layer-by-layer or volume-by-volume to form the structure, rather than removing material from an existing component to generate the three-dimensional structure. Additive manufacturing may be advantageous in many situations, such as rapid prototyping, forming components with complex three-dimensional structures, or the like. In some examples, additive manufacturing may utilize powdered materials and may melt or sinter the powdered material together in predetermined shapes to form the three-dimensional structures.

### SUMMARY

Additive manufacturing systems and techniques, such as directed energy deposition (DED) processes, operate by depositing material layer-by-layer to form an additively-manufactured component (hereinafter, “component”). In such processes, material is deposited by a powder delivery device directing a powder stream toward a melt pool formed on a build surface of the component by energy from an energy delivery device. The melt pool and added powder then solidify as an added layer. The added layer may become the new build surface for subsequent layers. Among other factors, alignment between a relative position of the powder stream to the melt pool may be important to the quality and efficiency of the additive manufacturing process. For example, if the powder stream is not in alignment with the melt pool, material in the powder stream may miss the melt pool or may be added to one portion of the melt pool at a greater rate than material added to another portion of the melt pool, resulting in reduced mass capture efficiency or asymmetric mass capture of powder by the melt pool. In such an unaligned state, underbuild, overbuild, or other problems may occur, leading to a build that is out of specification and ultimately discarding or reworking the component. Additive manufacturing systems of the present disclosure may address these and other problems by determining a relative position of the powder stream to the melt pool. In response to determining that the powder stream is not in alignment with the melt pool, a computing device of the additive manufacturing system may adjust the relative position of the powder stream to the melt pool. For instance, the computing device may adjust the position or settings of the powder delivery device, the energy delivery device, or both (e.g., to improve alignment of the powder stream and the melt pool). In this way, alignment between the powder stream and melt pool may be monitored and controlled, in-situ, during the additive manufacturing process. Such monitoring and control may desirably result in improved mass capture by the melt pool and a quality and efficient build.

An example additive manufacturing system includes an energy delivery device configured to deliver energy to a build surface of an additively-manufactured component to form a melt pool in the build surface of the component and a powder delivery device configured to direct a powder stream toward the melt pool. The system includes a powder flow monitoring system configured to observe the powder stream and an optical system configured to observe the melt pool. The system also includes a computing device configured to receive data indicative of a position of the powder stream from the powder flow monitoring system and receive data indicative of a position of the melt pool from the optical system. The computing system is configured to determine, based on the position of the powder stream and the position of the melt pool, a relative position of the powder stream to the melt pool, and control, based on the determined relative position of the powder stream to the melt pool, the powder delivery device and the energy delivery device.

An example method includes delivering, via an energy delivery device, energy to a build surface of an additively-manufactured component to form a melt pool in the build surface of the component and receiving, from an optical system, data indicative of a position of the melt pool. The technique includes delivering, via a powder delivery device, a powder stream to the melt pool to add material to the component and receiving, from a powder flow monitoring device, data indicative of a position of the powder stream. The technique includes determining, via a computing device, based on the position of the powder stream and the position of the melt pool, a relative position of the powder stream to the melt pool. The technique includes controlling, via the computing device, the energy delivery device or the powder delivery device.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a conceptual block diagram illustrating aspects of an example additive manufacturing system that includes a powder delivery device configured to direct a powder stream toward a melt pool formed by an energy delivery device.

FIG. 2 is a conceptual and schematic diagram illustrating further aspects of the additive manufacturing system of FIG. 1.

FIG. 3 is a conceptual diagram illustrating an example of portions of a powder stream imaged by a powder flow monitoring system.

FIG. 4 is an example calibration curve of particle detections versus mass flow.

FIG. 5 is a conceptual block diagram illustrating portions of the example additive manufacturing system of FIG. 1, including an optical system for observing thermal emissions around a melt pool and a thermal camera for monitoring a size of the melt pool.

FIG. 6 is a conceptual block diagram illustrating an example optical system for observing a melt pool formed during the additive manufacturing technique.

FIG. 7 is a process flow diagram illustrating a mass flux monitoring, heat flux monitoring, and alignment monitoring and control technique.

FIG. 8 is a conceptual and schematic diagram illustrating operation of a deposition head during an additive manufacturing process.

FIG. 9 is a conceptual and schematic diagram illustrating the deposition head of FIG. 8 in a misaligned state.

FIG. 10 is a conceptual and schematic diagram illustrating the deposition head of FIG. 8 under a control technique to align a powder stream and melt pool.

FIG. 11 is a conceptual and schematic diagram illustrating the deposition head of FIG. 8 under another control technique to align the powder stream and melt pool.

FIG. 12 is a flow diagram illustrating an example technique according to the present disclosure.

FIG. 13 is a flow diagram illustrating an example technique according to the present disclosure.

### DETAILED DESCRIPTION

The disclosure generally describes techniques and systems for managing residual stresses during an additive manufacturing technique, such as a directed energy deposition (DED) technique. During DED additive manufacturing, a component is built up by adding material to the component in sequential layers. The final component is composed of a plurality of layers of material. In some blown powder additive manufacturing techniques for forming components from metals, ceramics, and/or alloys, an energy source may direct energy at a substrate to form a melt pool. A powder delivery device may deliver a powder to the melt pool, where at least some of the powder at least partially melts and is joined to the melt pool and, thus, the substrate. In some examples, the powder delivery device and the energy delivery device may be part of a common deposition head configured to deliver both powder and energy to the build surface.

The properties of the final component, including the presence or absence of material defects (e.g., pores or void spaces, material not joined to adjacent material, and the like), and the efficiency with which material is added to the component, may be a function of the interaction between the powder stream and the melt pool. As such, measurement, modeling, control, and validation of the position of the powder stream from the powder delivery device and the melt pool formed by the energy delivery device of a blown powder additive manufacturing system (e.g., a DED system) may enable characterization or prediction of final component properties, control of the additive manufacturing technique during the process, quality assurance for the final component, development of new additive manufacturing techniques, and the like.

Challenges may arise while performing additive manufacturing techniques with additive manufacturing systems. For example, the powder stream and the melt pool may be out of alignment. The relative position of the powder stream to the melt pool may be considered out of alignment when the powder in the powder stream misses the melt pool or is added preferentially to only a portion of the melt pool. The system may become misaligned for many reasons, including one or more of a manufacturing error, an operator setup error, wear and tear on the system, bumps or jostles during an additive manufacturing process, or the like. Furthermore, some operations of the additive manufacturing system may cause, even temporarily, misalignment of the relative position of the powder stream to the melt pool. For example, a travel speed of a deposition head exceeding a certain threshold may cause powder to powder to displace from a central axis of the powder delivery device during flight across a working distance to the build surface, causing the powder stream to slightly trail behind the melt pool as the deposition head travels along a toolpath to deposit a layer. Similarly, in some examples, such as when a component with complex geometry is being fabricated and the powder stream is not coincident with the force of gravity, the gravitational force may act on the powder stream to displace the powder stream from the central axis of the powder delivery device, causing the relative position of the powder stream to the melt pool, at the build surface, to be different than the desired relative position of the powder stream to the melt pool.

Misalignment in the relative position of the powder stream to the melt pool at the build surface may cause one or more problems with the additive manufacturing process and the resulting component. For example, powder intended to be deposited on the component may miss the melt pool, causing reduced capture efficiency, wasted material, reduced layer thickness, and/or increased manufacturing time. Additionally, even when captured by the melt pool, the misaligned powder stream may be added preferentially to only a portion of the melt pool, which may cause underbuild (e.g., less material deposited than desired) in some portions of the layer and overbuild (e.g., more material deposited than desired) in other portions. Other asymmetric deposition behavior may be observed, depending on the travel direction.

In accordance with one or more examples of the current disclosure, additive manufacturing systems and techniques may address these and other problems. Additive manufacturing systems according to the present disclosure may include an energy delivery device configured to deliver energy to a build surface of an additively-manufactured component to form a melt pool in the build surface of the component and a powder delivery device configured to direct a powder stream toward the melt pool. The system may include a powder flow monitoring system configured to observe the powder stream and an optical system configured to observe the melt pool. The system may also include a computing device. The computing device may receive, from the powder flow monitoring system, data indicative of a position of the powder stream from the powder flow monitoring system, and receive, from the optical system, data indicative of a position of the melt pool. The computing device may determine, based on the position of the powder stream and the position of the melt pool, a relative position of the powder stream to the melt pool. The computing device may control, based on the determined relative position of the powder stream to the melt pool, the powder delivery device and the energy delivery device. In this way alignment between the powder stream and the melt pool may be monitored and controlled to improve the mass capture efficiency and quality of the additive manufacturing process and/or resulting component.

In some examples, to determine the position of the powder stream, the computing device may determine a position of a central axis of the powder stream, and to determine the position of the melt pool, the computing device may determine a position of a center point of the melt pool. The computing device may compare the position of the central axis of the powder stream to the position of the center point of the melt pool. Upon determination that a distance between the position of the central axis of the powder stream does not exceed a threshold distance, the computing device may determine that the additive manufacturing process may continue based on the validated relative position of the powder stream to the melt pool. Upon a determination that the distance between the central axis of the powder stream and the center point of the melt pool exceeds the threshold distance, the computing device may adjust the relative position of powder stream to the melt pool by adjusting the position or settings of the powder delivery device, the energy delivery device, or both to decrease the distance between position of the central axis of the powder stream to the center of the melt pool. In some examples, the computing device may adjust the relative position of the powder stream to the melt pool such that the central axis of the powder stream intersects the center point of the melt pool. Accordingly, powder of the powder stream may be delivered directly to the melt pool, symmetrically delivering powder to each portion of the melt pool evenly. In this way, additive manufacturing systems according to the present disclosure may monitor, control, and maintain alignment of the powder stream and the melt pool.

In some examples, the computing device may determine a capture efficiency of powder in the powder stream by the melt pool. For example, the computing device may compare the mass of powder delivered by a powder source through the powder delivery device to a mass of powder captured by the melt pool that is sensed by a topology sensor. In some examples, the computing device may adjust the relative position of the powder stream to the melt pool to increase the capture efficiency. For example, the computing device may store and execute a machine learning algorithm trained on the determined capture efficiency and the relative position of the powder stream to the melt pool, and adjust the powder delivery device and/or the energy delivery device based on output from the machine learning algorithm. The capture efficiency of the melt pool may thus be optimized and equalized, which may yield higher efficiency (e.g., reduced material waste, reduced layers to deposit a certain volume) and/or more uniform (e.g., more symmetric build) additively-manufactured components.

Although not necessary, in some examples the powder delivery device and the energy delivery device may be parts of a common deposition head. The deposition head may travel along a toolpath to deposit a layer of material during the build. The position of the powder delivery device and the position of the energy delivery device may each be independently controllable, which may allow for control of the relative position of the powder stream to the melt pool during manufacturing. For example, the energy delivery device may include a laser which delivers an energy beam through a portion of the deposition head. The laser may be mechanically supported one or more adjustable support members. The adjustable support members may allow for independent adjustment of the energy delivery device in the x, y, and/or z-directions relative to the remainder of the deposition head (e.g., the powder delivery device), which may allow for changing the position and/or size of the melt pool relative to the powder stream. Additionally, or alternatively, the energy delivery device may include one or more galvanometers or other mirror and/or lens systems. The position of the melt pool may be adjusted by manipulation of the one or more galvanometers.

In examples where the powder delivery device and the energy delivery device are parts of a common deposition head, the powder delivery device may direct the powder stream to the melt pool through one or more delivery nozzles at the downstream end of the deposition head. The position and/or angle of the one or more delivery nozzles may be manipulated by the computing device, which may allow for independent adjustment of the powder stream. In this way, the relative position of the powder stream to the melt pool may be adjusted.

In some examples, the computing device may adjust the relative position of the powder stream to the melt pool to account for forces acting on the powder stream as the powder travels across a working distance between the powder delivery device and the melt pool. For example, the powder stream central axis may be defined at the downstream end of the deposition head, and the powder stream may displace from the powder stream central axis when traveling across the working distance, such that the powder stream is displaced from the powder stream central axis by a displacement distance when the powder stream reaches the melt pool. For example, the travel speed of the deposition head along the toolpath may cause the displacement of the powder stream from the powder stream central axis. Additionally, or alternatively, the powder delivery device may direct the powder stream to the build surface at an angle with respect to gravity, and the powder stream may displace from the powder stream central axis due to the gravitational force.

The computing device may account for displacement distance of the powder stream due to the speed of the deposition head and/or the gravitational force by adjusting the relative position of the powder stream to the melt pool. For example, the powder stream central axis, which may be defined at a downstream end of the deposition head, may be positioned ahead of the melt pool along the toolpath, which may be called a leading position. The powder stream may displace from the powder stream central axis along the toolpath as the powder travels across the working distance between the deposition head and the build surface. Since in such examples the position of the melt pool may slightly trail behind the powder stream central axis along the toolpath, the powder in the powder stream may land in the melt pool. Since the displacement distance may be a function of the travel speed of the deposition head along the toolpath, in some examples the computing device may increase the amount by which the powder stream central axis leads the melt pool in response to an increase in travel speed of the deposition head. In this way, the computing device may account for the displacement distance by adjustment of the relative position of the powder stream to the melt pool. The computing device may similarly account for displacement distances resulting from the force of gravity or other forces, such as those forces due to powder carrier gases rebounding from the component or the like.

The displacement distance may depend on a number of additional parameters of the additive manufacturing system. For example, a deposition head speed, size distribution and density of the powder, energy beam shape, energy beam power and spot size, melt pool size, powder feed rate, a process gas flow rate, or velocity, or direction, and/or working distance may all be settings to the system which impact the optimized relative position of the powder stream to the melt pool. In some examples, the computing device may receive indications of some or all of these additional parameters, and may adjust the relative position of the powder stream to the melt pool based at least partially on one or more of these parameters. For example, these and/or other parameters may be input into the machine learning algorithm, which may output a control signal to position the energy delivery device, the powder delivery device, or both during an additive manufacturing technique. While primarily described herein as systems and techniques configured to align the powder stream with the melt pool, in some examples the disclosed systems and techniques may deliberately misalign and maintain and control the misalignment of the powder stream to the melt pool where such misalignment is found advantageous for a specific process.

In some examples, the computing device may maintain the relative position of the powder stream to the melt pool throughout a portion of the additive manufacturing process. For example, the relative position may be maintained throughout deposition of a layer. Controlled maintenance of the relative position of the powder stream to the melt pool may yield improved quality and uniformity of the part.

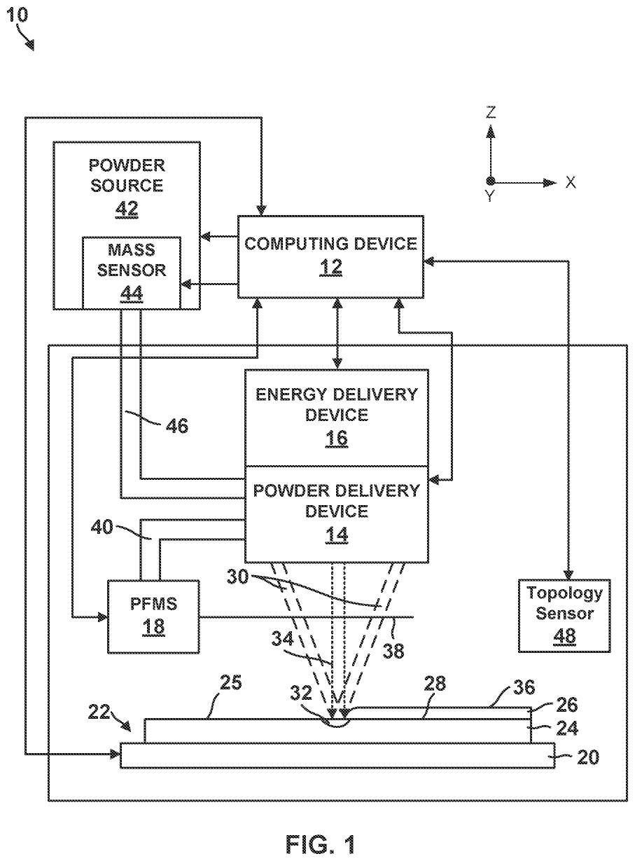

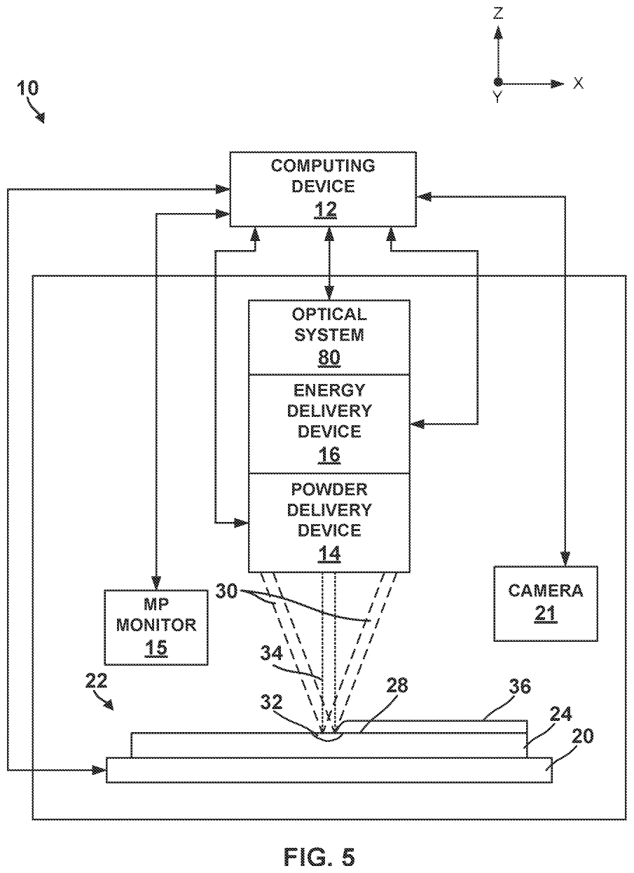

FIG. 1 is a conceptual block diagram illustrating aspects of an example additive manufacturing system 10. Additive manufacturing system 10 includes several components configured to monitor mass flow, and several components configured to monitor energy (e.g., heat flux) within system 10. System 10 includes a powder source mass sensor 44, a powder flow monitoring system (PFMS) 18, and a topology sensor 48. These components are configured to monitor mass flow of powder within additive manufacturing system 10 during an additive manufacturing technique. In the example illustrated in FIG. 1, additive manufacturing system 10 further includes a computing device 12, a powder delivery device 14, an energy delivery device 16, a stage 20, a powder source 42, powder source mass sensor 44, and topology sensor 48. Computing device 12 is operably connected to powder delivery device 14, energy delivery device 16, PFMS 18, stage 20, powder source 42, powder source mass sensor 44, and topology sensor 48. FIG. 1 thus illustrates mass flow monitoring and other aspects of example additive manufacturing system 10. To simplify illustration of FIG. 1 and improve clarity of the figure, further aspects of additive manufacturing system 10 are shown in FIG. 5 and described below with reference to FIG. 5, which is more directed toward heat flow aspects of system 10.

Stage 20 is configured to mechanically support a component 22 during an additive manufacturing technique. Component 22 may be considered in-situ when mechanically supported by stage 20. In some examples, stage 20 is movable relative to energy delivery device 16 and/or energy delivery device 16 is movable relative to stage 20. Similarly, stage 20 may be movable relative to powder delivery device 14 and/or powder delivery device 14 may be movable relative to stage 20. For example, stage 20 may be translatable and/or rotatable along at least one axis to position component 22 relative to energy delivery device 16 and/or powder delivery device 14. Similarly, energy delivery device 16 and/or powder delivery device 14 may be translatable and/or rotatable along at least one axis to position energy delivery device 16 and/or powder delivery device 14, respectively, relative to component 22. Stage 20 may be configured to selectively position and restrain component 22 in place relative to stage 20 during manufacturing of component 22.

Powder source 42 is the source of powder for powder stream 30. Powder source 42 may include any suitable container or enclosure, such as a hopper, configured to hold powder. Powder source 42 also may include mechanism for entraining the powder in a gas flow. For instance, powder source 42 may be coupled to a gas source, which provides a gas flowing through powder source 42 and entraining powder within the gas flow. Additionally, or alternatively, powder source 42 may include an agitator configured to agitate the powder and increase entrainment of the powder in the gas stream.

System 10 may include a powder source mass sensor 44 associated with powder source 42. Powder source mass sensor 44 may be configured to quantify loss of mass in the powder source 42 or, alternatively, a mass flow out of powder source 42.

Powder source 42 is fluidically coupled to powder delivery device 14 via a flow path 46. Flow path 46 may include any suitable structure(s) defining an enclosed flow between powder source 42 and powder delivery device, including conduit, pipe, tubes, or the like. Although not shown in FIG. 1, for at least part of flow path 46 between powder source 42 and nozzles of powder delivery device 14, flow path 46 may split into multiple, parallel sections, e.g., one for each nozzle. Further, although not shown in FIG. 1, in some examples, flow path 46 may include one or more nozzles for controlling flow through flow path 46 as a whole or portions of flow path 46 (e.g., a section associated with a particular nozzle of powder delivery device 14).

Powder delivery device 14 may be configured to deliver powder to selected locations of component 22 being formed via a powder stream 30. Powder delivery device 14 may include one or more nozzles that each output powder. The combined powder defines powder stream 30. In some examples, powder delivery device 14 includes a single nozzle, which may be point nozzle, or a single nozzle that is an annular channel. In other examples, powder delivery device 14 includes a plurality of nozzles (e.g., three nozzles or four nozzles). Regardless of the number of nozzles, powder delivery device 14 may output a powder stream that is focused at a focus plane. In some examples, the powder delivery device may define a powder stream central axis. The powder stream central axis may be coincident with a delivery channel in examples where the powder delivery device includes a single nozzle. In examples where the powder delivery device includes multiple nozzles, the powder stream central axis may be defined at the downstream end of the powder delivery device as normal to build surface 28 and equidistant from each delivery nozzle of the plurality of delivery nozzles. As powder delivery device 14 is movable in the z-axis shown in FIG. 1 relative to component 22, the focal plane of powder delivery device 14 also may be movable in the z-axis relative to component 22, such that the focus plane may be controlled to be substantially coincident with build surface 28.

At least some of the powder in powder stream 30 may impact a melt pool 32 in component 22. At least some of the powder that impacts melt pool 32 may be joined to component 22. In some examples, powder delivery device 14 may be mechanically coupled or attached to primary energy delivery device 16 to facilitate delivery of powder stream 30 and energy 34 for forming melt pool 32 to substantially the same location adjacent to component 22. As will be further described below, the relative position of powder stream 30 to melt pool 32 may be adjustable by computing device 12, which may be advantageous when compared to conventional additive manufacturing systems where the spatial relationship between powder stream 30 and melt pool 32 is fixed.

Energy delivery device 16 may include an energy source, such as a laser source, an electron beam source, plasma source, or another source of energy that may be absorbed by component 22 to form a melt pool 32 and/or be absorbed by powder in powder stream 30 to be added to component 22. Example laser sources include a CO laser, a CO₂ laser, a Nd:YAG laser, or the like. In some examples, the energy source may be selected to provide energy with a predetermined wavelength or wavelength spectrum that may be absorbed by component 22 and/or the powder to be added to component 22 during the additive manufacturing technique.

In some examples, energy delivery device 16 also includes an energy delivery head, which is operatively connected to the energy source. The energy delivery head may aim, focus, or direct energy 34 toward predetermined positions at or adjacent to a surface of component 22 during the additive manufacturing technique. As described above, in some examples, the energy delivery head may be movable in at least one dimension (e.g., translatable and/or rotatable) under control of computing device 12 to direct energy 34 toward a selected location at or adjacent to build surface 28 of component 22. Energy delivery device 16 may be configured to focus energy 34 from the energy source on a local spot on build surface 28 to generate melt pool 32. As will be further described below, energy delivery device 16 may include one or more mechanisms to adjust the position of energy 34 and thus melt pool 32. For example, energy delivery device 16 may direct energy 34 through an optical system that includes one or more galvanometers and/or one or more lenses. Additionally, or alternatively, energy delivery device 16 may be mounted on one or more adjustable support members, which may be adjusted by computing device 12. The galvanometers, lenses, and/or adjustable support members may be adjusted by computing device 12 to modify and selectively tailor the position of energy 34, and, accordingly, the position of melt pool 32 on build surface 28.

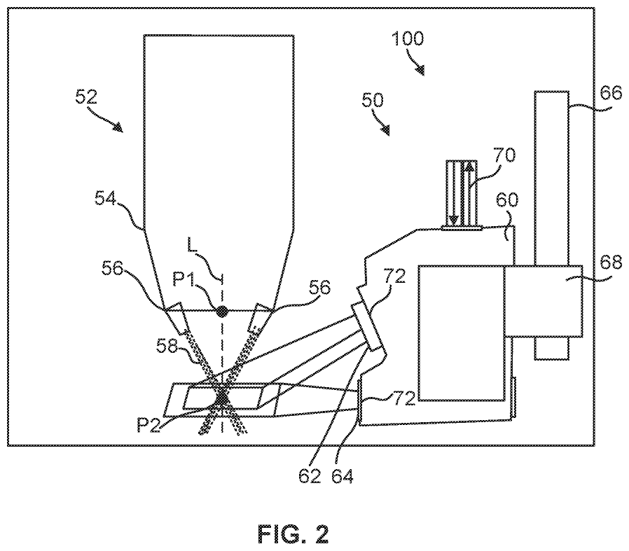

In some examples, at least a portion of primary energy delivery device 16 and powder delivery device 14 may be combined or attached to each other. For example, a deposition head (e.g., deposition head 54 of FIG. 2) may include part of powder delivery device 14 (e.g., internal channels and powder nozzle(s) 56 for forming powder stream 30 and directing powder stream 30 toward build surface 28) and part of primary energy delivery device 16 (e.g., the energy delivery head). As shown in FIG. 1, in some examples, primary energy delivery device 16 may be arranged of configured such that energy 34 and powder stream 30 both exit from a common deposition head (54, FIG. 2) and are directed toward build surface 28. For instance, energy 34 may pass through a central channel (e.g., formed along central longitudinal axis L, FIG. 2) within the deposition head and exit a central aperture in the deposition head, while fluidized powder may flow through internal channels and powder nozzle(s) 56 for forming powder stream 30 and directing powder stream 30 toward build surface 28. Such an arrangement between primary energy source 16 and powder delivery device 14 may be called an “on-axis” arrangement of primary energy source 16, because both energy and powder may be delivered coaxially with a central longitudinal (Z-direction) axis of the deposition head.

System 10 also includes powder flow monitoring system (PFMS) 18. PFMS 18 is configured to image at least a portion of powder stream 30 to detect powder flowing between powder delivery device 14 and build surface 28. For example, PFMS 18 may include an illumination device and an imaging device. In some examples, the illumination device may include one or more light sources. For instance, the illumination device may include one or more structured light devices, such as one or more lasers. The illumination device is configured to illuminate a plane of powder stream 30 at image plane 38, e.g., a plane substantially perpendicular to an axis extending between powder delivery device 14 and build surface 28 (e.g., central longitudinal axis L).

The imaging device of PFMS 18 is configured to image at least some of the illuminated powder. The imaging device may have a relatively high data acquisition speed (e.g., frame rate), such greater than 1000 Hz. Because of the velocity of the powder in powder stream 30, even such a frame rate may image only a fraction of the powder flowing between powder delivery device 14 and build surface 28. In some examples, the imaging device may be a camera.

In some examples, PFMS 18 also includes a housing configured to enclose the illumination device and the imaging device. The housing may be configured to protect the illumination device and the imaging device from damage due to the harsh conditions to which PFMS 18 may be exposed during use. For example, the housing may protect the illumination device and the imaging device from powder deflections from powder stream 30 off build surface 28, may cool the illumination device and the imaging device to remove heat incident on PFMS 18 from melt pool 32 and energy delivery device 16, or the like.

PFMS 18 may be positionally fixed relative to powder delivery device 14 and/or energy delivery device 16, e.g., in the x-y plane shown in FIG. 1. This may help maintain a relative x-y position of PFMS 18 and the image plane of the imaging device relative to powder stream 30. This may facilitate analysis of image data captured by the imaging device.

PFMS 18 may be movable in the z-axis direction of FIG. 1 (e.g., parallel to a longitudinal axis extending from powder delivery device 14 to build surface 28). This may enable movement of image plane 38 along the z-axis of FIG. 1 (e.g., parallel to a longitudinal axis extending from powder delivery device 14 to build surface 28). This may allow PFMS 18 to image powder stream 30 at different positions between powder delivery device 14 and build surface 28. In this way, PFMS 18 may analyze powder stream 30 along powder stream 30 to help determine parameters of powder stream 30 along its length.

In some example, PFMS 18 may be positionally fixed relative to powder delivery device 14 and/or energy delivery device 16 and movable parallel to a longitudinal axis extending from powder delivery device 14 to build surface 28 by an adjustable z-stage 40. Adjustable z-stage 40 may be attached to energy delivery device 16, powder delivery device 14, or a portion of system 10 that moves energy delivery device 16 and/or powder delivery device 14, such that PFMS 18 moves in the x-y axis in registration with energy delivery device 16 and/or powder delivery device 14.

Adjustable z-stage 40 may be controlled by computing device 12 to position PFMS 18 and image plane 38 relative to powder stream 30. Further, computing device 12 may control adjustable z-stage 40 to move PFMS 18 vertically and out of the way to allow powder delivery device 16 and energy delivery device 16 access to physically constrained areas, e.g., between vanes of a doublet or triplet of a nozzle guide vane for a gas turbine engine.

System 10 further includes a topology sensor 48. Topology sensor 48 is configured to monitor an amount of powder captured by melt pool 32 by imaging melt pool 32 and the added material, allowing the mass to be quantified (e.g., by computing device 12) using the dimensions of the added material and density of the material (powder). In some examples, topology sensor 48 includes a laser and a sensor (e.g., an imaging device, such as a camera), which senses laser light reflected by the structure being imaged (e.g., melt pool 32 and the added material). The laser may have a defined wavelength, which may affect the resolution of the topology sensor 48. In some examples, the wavelength and sensor may be selected such that the resolution of topology sensor 48 is a great as about 10 microns (e.g., about 6 microns).

In some examples, topology sensor 48 may be positioned substantially directly above component 22 (e.g., along a central axis of powder delivery device 14, energy delivery device 16, or a common deposition head that includes both powder delivery device 14 and energy delivery device 16) and may include an interferometer, which provides depth information based on the time from outputting a laser pulse to the sensing of the reflected light. In other examples, topology sensor 48 may be positioned at an offset with respect to component 22 such that the sensor senses depth information without using an interferometer.

In some examples, topology sensor 48 may be integral with system 10, e.g., disposed within the enclosure or working area of system 10. In other examples, topology sensor 48 may be an add-on component to system 10. For example, the enclosure in which the additive manufacturing technique is performed may include a transparent window, and topology sensor 48 may be positioned outside of the enclosure and may image component 22 through the transparent window.

Although a topology sensor 48 is described in the examples of this disclosure, in other examples, another metrology device may be utilized to determine the amount of powder captured by melt pool 32. For example, another type of light source may be used. In some examples, if another type of light source is used, component 22 or stage 20 may include one or more features that serve as indicators of scale. Furthermore, although described as a single topology sensor 48, more than one sensor may be used, and may employ more than one of the technologies described above.

Computing device 12 may control components of system 10 and may include, for example, a desktop computer, a laptop computer, a workstation, a server, a mainframe, a cloud computing system, or the like. Computing device 12 may control operation of system 10, including, for example, powder delivery device 14, energy delivery device 16, PFMS 18, stage 20, powder source 42, powder source mass sensor 44, and/or topology sensor 48. Computing device 12 may be communicatively coupled to powder delivery device 14, energy delivery device 16, PFMS 18, stage 20, powder source 42, powder source mass sensor 44, and/or topology sensor 48 using respective communication connections. In some examples, the communication connections may include network links, such as Ethernet, ATM, or other network connections. Such connections may be wireless and/or wired connections. In other examples, the communication connections may include other types of device connections, such as USB, IEEE 1394, or the like.

Computing device 12 may include one or more processors. Example of processors include, but are not limited to, one or more microprocessors, digital signal processors (DSPs), application specific integrated circuits (ASICs), field programmable gate arrays (FPGAs), or any other equivalent integrated or discrete logic circuitry, as well as any combinations of such components. Computing device 12 may include a memory, and the memory may store instructions for various operations of system 10.

Although FIG. 1 illustrates a single computing device 12 and attributes all control and processing functions to that single computing device 12, in other examples, system 10 may include multiple computing devices 12, e.g., a plurality of computing devices 12. In general, control and processing functions described herein may be divided among one or more computing devices. For instance, system 10 may include a controller for energy delivery device 16, powder delivery device 14, and stage 20, a separate controller for PFMS 18, and a separate computing device for analyzing data obtained by PFMS 18, mass sensor 44, and topology sensor 48. As another example, system may include a dedicated controller for each of energy delivery device 16, powder delivery device 14, stage 20, PFMS 18, and topology sensor 48, and a separate computing device for coordinating control of powder delivery device 14, energy delivery device 16, PFMS 18, stage 20, powder source 42, powder source mass sensor 44, and/or topology sensor 48 and analyzing data obtained by PFMS 18, powder source mass sensor 44, and/or topology sensor 48. Other examples of computing system architectures for controlling system 10 and analyzing data obtained from system 10 will be apparent and are within the scope of this disclosure.

Computing device 12 may control operation of powder delivery device 14, primary energy delivery device 16, secondary energy delivery device 17, adjustable z-stage 40, stage 20, and/or topology sensor 48 to position component 22 relative to powder delivery device 14, energy delivery device 16, PFMS 18, and topology sensor 48. For example, as described above, computing device 12 may control stage 20 and powder delivery device 14, energy delivery device 16, adjustable z-stage 40, and/or topology sensor 48, to translate and/or rotate along at least one axis to position component 22 relative to powder delivery device 14, energy delivery device 16, PFMS 18, and topology sensor 48. Positioning component 22 relative to powder delivery device 14, energy delivery device 16, PFMS 18, and topology sensor 48 may include positioning a predetermined surface (e.g., build surface 28, a surface to which material is to be added) of component 22 in a predetermined orientation relative to powder delivery device 14, energy delivery device 16, PFMS 18, and/or topology sensor 48.

Computing device 12 may control system 10 to deposit layers 24 and 26 to form component body 25 and eventually finished component 22. As shown in FIG. 1, component 22 may include a first layer 24 and a second layer 26, although many components may be formed of additional layers, such as tens of layers, hundreds of layers, thousands of layers, or the like. Component 22 in FIG. 1 is simplified in geometry and the number of layers compared to many components formed using additive manufacturing techniques. Although techniques are described herein with respect to component 22 including first layer 24 and second layer 26, the technique may be extended to components 22 with more complex geometry and any number of layers. Furthermore, although component 22 is illustrated as being uniform, in some examples component 22 may be functionally-graded and include at least two different portions having different selectively tailored properties.

To form component 22, computing device 12 may control powder delivery device 14 and energy delivery device 16 to form, on build surface 28 of first layer 24 of material, a second layer 26 of material using an additive manufacturing technique. Computing device 12 may control primary energy delivery device 16 to deliver energy 34 to a volume at or near surface 28 to form melt pool 32. For example, computing device 12 may control the relative position of energy delivery device 16 and stage 20 to direct energy to the volume. Computing device 12 also may control powder delivery device 14 to deliver powder stream 30 to melt pool 32. For example, computing device 12 may control the relative position of powder delivery device 14 and stage 20 to direct powder stream 30 at or on to melt pool 32. The position of powder stream 30 and melt pool 32 may be independently controlled by computing device 12, such that the relative position of powder stream 30 to melt pool 32 may be selectively controlled as part of an additive manufacturing technique, in accordance with examples of this disclosure. The relative position of powder stream 30 to melt pool 32 may even be independently controlled when powder delivery device 14 and energy delivery device 16 are parts of a common deposition head (54, FIG. 2). Such independent control of powder delivery device 14 and energy delivery device 16 during an additive manufacturing process may permit adjustment of the relative position of powder stream 30 to melt pool 32 to account for settings and parameters of system 10 during operation.

Computing device 12 may then control a z-axis position of stage 20 and/or powder delivery device 14 and energy delivery device 16 such that melt pool 32 will be formed on surface 36 of second layer 26, and may control powder delivery device 14 and energy delivery device 16 to move energy 34 and powder stream 30 along build surface 28 in a pattern until layer 26 is complete. Computing device 12 may control powder delivery device 14 and energy delivery device 16 similarly until all layers are formed to define a completed component 22.

Computing device 12 may control powder delivery device 14 and primary energy delivery device 16 to move energy 34 and powder stream 30 along build surface 28 in a pattern until layer 26 is complete. As mentioned above, powder delivery device 14 and energy delivery device 16 may be parts of a common deposition head, and computing device 12 may control the deposition head (54, FIG. 2) to move along a toolpath to deposit layer 26. Computing device 12 may receive, from PFMS 18, data indicative of the position of powder stream 30. Computing device 12 may also receive, from an optical system configured to observe the melt pool, data indicative of a position of the melt pool on build surface 28. The absolute position of powder stream 30 and melt pool 32 may be defined relative to common deposition head (54, FIG. 2), or may be defined with respect to a point cloud model of dimensions of final component 22. Computing device 12 may determine the relative position of powder stream 30 to melt pool 32 based on the determined absolute positions of powder stream 30 and melt pool 32. Computing device 12 may control powder delivery device 14 and/or energy delivery device 16 based on the determined relative position of powder stream 30 to melt pool 32.

In some examples, computing device 12 may store/execute one or more machine learning models which may be used to adapt control of powder delivery device 14, primary energy delivery device 16, secondary energy delivery device 17, or another component. For example, data captured by one or more thermal sensors, energy delivery device 16, PFMS 18, topology sensor 48, mass source 44, or other components of system 10 may be used to train the machine learning device. Furthermore, additional parameters of system 10 may be inputs to a machine learning model, such as operational settings of system 10.

FIG. 2 is a conceptual and schematic diagram illustrating example additive manufacturing system 100. Additive manufacturing system 100 of FIG. 2 may be an example of additive manufacturing system 10 of FIG. 1. System 100 includes an example powder flow monitoring system 50 configured to monitor powder flow between a powder delivery device 52 and a build surface (not shown in FIG. 2) during an additive manufacturing technique. Powder delivery device 52 may be an example of powder delivery device 14 of FIG. 1, and PFMS 50 may be an example of PFMS 18 of FIG. 1.

Powder delivery device 52 includes a deposition head 54 that carries a plurality of delivery nozzles 56. Plurality of delivery nozzles 56 output a powder stream 58 toward the build surface. As shown in FIG. 2, the powder stream 58 may be focused at a focal plane, such that powder stream 58 is converging toward the focal plane and diverging away from the focal plane. As discussed above, deposition head 54 may further include energy delivery device 16, which is not illustrated in FIG. 2 for improved clarity. Powder delivery device 52 may define powder stream central axis L. In examples where powder delivery device 52 includes a single delivery nozzle 56, central axis L may pass through the single delivery nozzle. In some examples, as illustrated, powder delivery device 52 may include plurality of delivery nozzles 56, and powder stream central axis L may be defined between point P1 and point P2. Point P1 may be the point equidistant from plurality of delivery nozzles 56 on the downstream end, relative to powder flowing through powder delivery device 52, of powder delivery device 52. Point P2 may be the point at which powder from the plurality of delivery nozzles 56 converges, which may be at the build surface (28, FIG. 1) of a component. In some examples, the energy delivery device (not illustrated in FIG. 2 for clarity), may be configured to deliver energy to the build surface parallel to (e.g., coincident with) powder stream central axis L.

PFMS 18 includes a housing 60 (also referred to as an enclosure), which encloses an imaging device 62 and an illumination device 64. In some examples, imaging device 62 may be a high-speed camera and illumination device 64 may be laser illuminator. Housing 60 is attached to an adjustable z-stage 66 by a bracket 68.

Housing 60 may enclose imaging device 62 and illumination device 64 and help protect imaging device 62 and illumination device 64 from a surrounding environment. For instance, housing 60 may surround imaging device 62 and illumination device 64 and prevent any powder that reflects from the build surface toward PFMS 18 from impacting imaging device 62 or illumination device 64.

Further, housing 60 may be configured to cool imaging device 62 and illumination device 64. Imaging device 62 and illumination device 64 may be exposed to heat from the melt pool at the build surface and energy from the energy delivery device. Imaging device 62 and illumination device 64 may be relatively sensitive to heat and have improved operational lifetime if maintained and operated below a certain temperature. PFMS 50 may include a cooling system 70 that removes heat from within housing 60 to cooling imaging device 62 and illumination device 64. For instance, cooling system 70 may include cooling fluid circuit through which a cooling fluid flows, and housing 60 may include part of the cooling circuit. In some examples, housing 60 may be formed from a material having relatively high thermal conductivity, such as aluminum, to help transfer heat from within housing 60 to cooling system 70 (e.g., a cooling fluid flowing through cooling system 70).

As described above, PFMS 50 may be configured to measure powder flow of powder stream 58 (FIG. 2) at one or more axial (or longitudinal) locations of powder stream 58 and determine one or more parameters associated with the powder flow. For instance, PFMS 50 may be determine a position of powder stream, either absolutely with respect to system 100 or with respect to deposition head 54, the position of which may be known relative to system 100. For instance, illumination device 64 may illuminate powder of powder stream 58 in a plane oriented substantially orthogonal to a longitudinal axis that extends from powder delivery device 52 to the build surface. PFMS 50 may be positioned at a selected axial or longitudinal location to image a selected axial or longitudinal position between powder delivery device 52 and the build surface. Imaging device 62 may be a camera configured to image at least some of the illuminated powder.

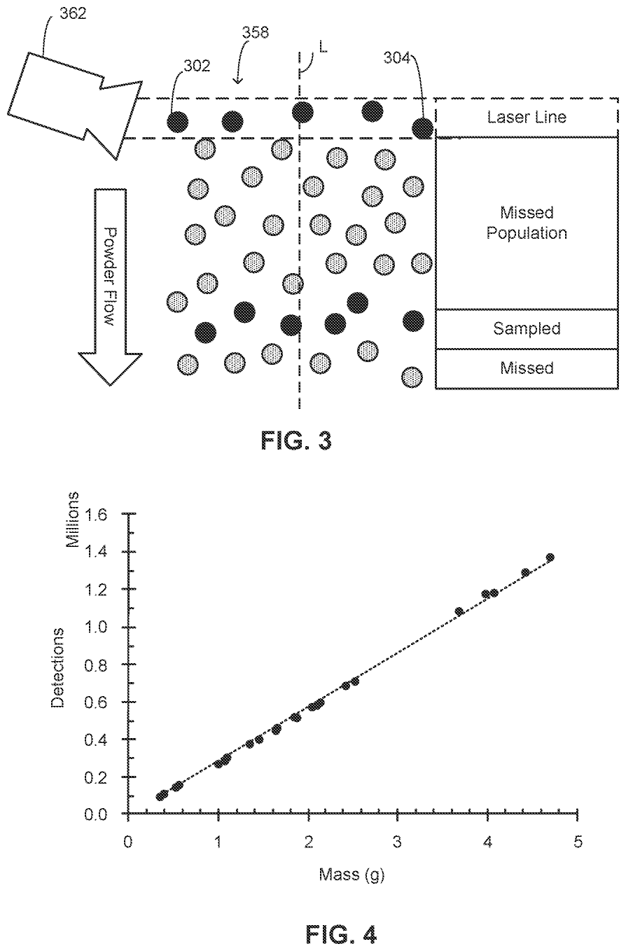

FIG. 3 is a conceptual diagram illustrating an example of portions of a powder stream imaged by a powder flow monitoring system. As shown in FIG. 3, since powder is flowing in powder stream 358 at a relatively high velocity, imaging device 362 may not capture images of all the powder in powder stream 358. The fraction of powder that imaging device 362 captures images of may be a function of average powder velocity at the image plane and a frame rate or capture speed of imaging device 362. This is represented in FIG. 3 as “sampled” particles and “missed population” particles. The fraction of particles imaged by imaging device 362 may, in some examples, be less than about 50%, less than about 40%, less than about 30%, less than about 25%, less than about 20%, or less than about 15%.

PFMS 50 may include a computing device (e.g., computing device 12 of FIG. 1) configured to analyze images captured by imaging device 62 to identify a number of particle detections in each captured image and, optionally, derive further parameters from the number of particle detections. As such, computing device 12 may receive image data representing an image captured by imaging device 362. The image data may include representations of illuminated powder of powder stream 358, as imaged by imaging device 362 (e.g., as captured in an image frame by imaging device 362). Computing device 12 may generate a representation of powder stream based on the image data and output the representation of the powder stream for display at a display device.

Computing device 12 may analyze the image data representative of powder stream 358 to determine one or more aspects of the position of powder stream 358. For instance, computing device 12 may recognize powder particles 302, 304. Powder particles 302, 304 may be located at respective extremes of the width of powder stream 358. In some examples, for example where the powder delivery device includes on a single delivery nozzle, powder stream central axis L may be defined as midway between powder particles 302, 304. Computing device 12 may determine the position of powder stream 358 based on the position of particles 302, 304, powder stream central axis L, or combinations thereof.

In some examples, computing device 12 may determine a powder mass flow represented by the image data. To do so, computing device 12 may identify a number of powder particles within each image frame. In some examples, computing device 12 additionally may identify a size and/or shape of each powder particle within each image frame. Computing device 12 may implement any suitable image analysis technique to identify powder particles, and, optionally, size and/or shape of powder particles. Since the position of imaging device 362, either absolutely within the additive manufacturing system of relatively with respect to an associated deposition head, may be known, the position of powder stream 358 may be determined by the position of powder stream 358 within the image frame.

Once computing device 12 has identified a number of powder particles within an image frame, computing device 12 may determine a mass flow based on the number of powder particles. For example, computing device 12 may determine the mass flow based on a calibration equation or calibration curve. FIG. 5 is an example calibration curve of particle detections versus mass flow. As shown in FIG. 4, the relationship between particle detections may be substantially linear.

The relationship between particle detections and mass flow may be determined experimentally. For instance, the relationship between particle detections and mass flow may be determined for each powder type (e.g., composition, size distribution, or both), as each powder type may have a different relationship between particle detections and mass flow. The relationship may be determined experimentally by flowing a known mass of powder at a known rate, and imaging the powder. By doing this multiple times at multiple rates, the calibration curve may be generated. The curve, in the form of an equation, a look-up table, or the like, may be stored in computing device 12, and computing device 12 may use the calibration curve to determine mass flow of a similar type of powder at a different flow rate based on particle detections.

In some examples, computing device 12 may receive image data representative of a sequence of images of illuminated powder in powder stream 58. Each image may be associated with a time. As such, computing device 12 may select one or more images of the sequence of images and analyze the one or more images. For each selected image, computing device 12 may identify a number of particle detections and, optionally, determine a mass flow associated with powder stream 58 for each image frame.

As described above, system 10 may include both mass flow monitoring and heat flow monitoring. FIG. 1 best illustrates the mass flow monitoring aspects of system 10. FIG. 5 is a conceptual block diagram illustrating further aspects of system 10, best illustrating the heat flow monitoring aspects of the example system. System 10 includes an optical system 80 for observing thermal emissions around melt pool 32, a melt pool monitor (MP monitor) 15 including a thermal camera for monitoring a size and/or temperature of melt pool 32, and an optional off-axis camera 21. Identical reference numerals in FIGS. 1 and 5 refer to the same parts. Further, those common parts are the same or substantially identical, aside from any differences described herein. As shown in FIG. 5, energy delivery device 16 includes an optical system 80.

During additive manufacturing, component 22 is built up by adding material to component 22 in sequential layers. The final component is composed of a plurality of layers of material. Energy delivery device 16 may direct energy 34 at build surface 28 of first layer 24 to form melt pool 32. Powder delivery device 14 may deliver powder stream 30 to melt pool 32, where at least some of the powder at least partially melts and is joined to first layer 24. Melt pool 32 cools as energy 34 is no longer delivered to that location of first layer 24 (e.g., due to energy delivery device 16 scanning energy 34 over the surface of first layer 24). The temperature and cooling rate of melt pool 32 and the surrounding areas of first layer 24 affect the microstructure, porosity, temper, and other properties of component 22 formed using the additive manufacturing technique. Further, these and other properties of component 22 may be impacted by the relative position of powder stream 30 to melt pool 32. Optical system 80, MP monitor 15, and/or camera 21 may capture data indicative of the position of melt pool 32, and computing device 12 may analyze the captured data and determine the position of melt pool 32, either absolutely within system 10 or relatively with respect to an associated deposition head.

Optical system 80 may include an imaging device and an associated optical train, which senses emissions at or near component 22 during the additive manufacturing technique. For example, optical system 80 may include a visible light imaging device, an infrared imaging device, or an imaging device that is configured (e.g., using a filter) to image a specific wavelength or wavelength range.

The optical train may include one or more reflective, refractive, diffractive optical components configured to direct light to the imaging device. For example, the optical train may be configured to direct light from near component 22 and/or melt pool 32 to the imaging device. In some examples, at least a portion of the optical train is coaxial with the axis at which energy delivery device 16 outputs energy, and the at least a portion of the optical train may be attached to or otherwise configured to move with the portion of energy delivery device 16 that directs or focuses energy 34 at or near the surface of component 22. In this way, optical system 80 may move with energy delivery device 16 and track melt pool 32 as melt pool 32 moves across component 22, without needing to correct for any offsets between energy delivery device 16 and optical system 80 and/or needing to correct for geometry of component 22. In other examples, the optical train may not be coaxial with the axis at which energy delivery device 16 outputs energy 34, and computing device 12 may be configured to compensate for the offset and any affects this may have on the imaging, including shadowing, interference, geometry of component 22, or the like. Off-axis camera 21, which is a second camera not coaxial with the axis at which energy delivery device 16 outputs energy 34m may be configured to determine the position of melt pool 32 within system 10 by imaging energy 34 and/or melt pool 32 from a known (e.g., fixed) position within system 10.

In some examples, optical system 80 may include an occulting device. The occulting device is configured to reduce or block emissions (e.g., thermal emissions) that originate from the energy output by energy delivery device 16 and/or near a center of melt pool 32, which otherwise obfuscate emissions from solidifying regions of material at or near the edge of melt pool 32 and outside of melt pool 32. The occulting device may be a rigid occulting device or a dynamic occulting device. A rigid occulting device reduces or blocks emissions from a fixed region, e.g., from the energy 34 output by energy delivery device 16. For instance, a rigid occulting device may include a device with fixed dimensions that is opaque to wavelengths of interest. As another example, a rigid occulting device may include an apodizing lens in which a center of the lens if substantially opaque to wavelengths of interest and opacity decreases as a function of radius.

A dynamic occulting device is configured to be controlled to occult different regions, e.g., different sizes and/or shapes. A dynamic occulting device may include a rigid occulting device that is mounted to a device that can translate the rigid occulting device along and/or perpendicularly to the optical axis. As another example, a dynamic occulting device may include an opaque and viscous liquid, such as mercury, contained between two substrates. The substrates are substantially transparent to the wavelength(s) of interest. One or both of the substrates may be movable relative to the other substrate to control the distance between the substrates. By reducing the distance between the substrates, the size of the occulting region may increase. By increasing the distance between the substrates, the size of the occulting region may decrease. As a third example, a dynamic occulting device may include a digital micromirror device. Computing device 12 may control the micromirrors of the digital micromirror device to direct emissions that originate from energy 34 output by energy delivery device 16 and/or near a center of the melt pool away from the imaging device. A digital micromirror device may enable control of both the size and shape of the region of emissions that are occulted. As will be further discussed below, computing device 12 may a digital micromirror device within energy delivery device 16, which may be a galvanometer, or another digital micromirror device, to adjust the position of energy 34, and this the position of melt pool 32.

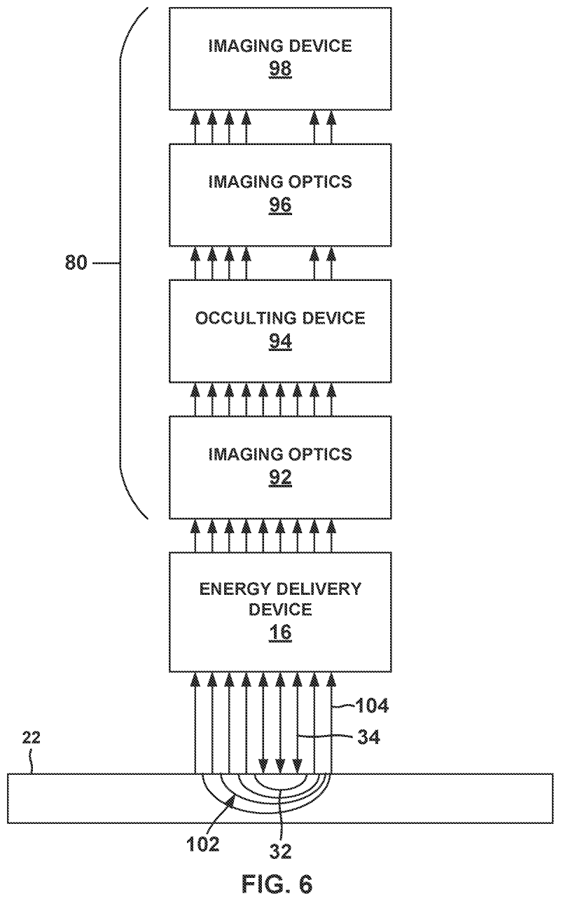

FIG. 6 is a conceptual block diagram illustrating an example optical system 80 for observing thermal emissions at and/or around a melt pool 32 and or a focused spot on a build surface 28 where a melt pool is not formed (e.g., by second energy delivery device 17, FIGS. 1 and 5) formed during an additive manufacturing technique. Optical system 80 includes an optical train that includes first imaging optics 92, occulting device 94, second imaging optics 96, and imaging device 98. Imaging device 98 may be any suitable imaging device, including, for example, a visible light imaging device, an infrared imaging device, an imaging device that is configured (e.g., using a filter) to image a specific wavelength or wavelength range, a two color pyrometry imaging device, or the like.

First and second imaging optics 92 and 96 may each include one or more optical devices used to direct light to imaging device 98. For example, First and second imaging optics 92 and 96 may each include one or more refractive optical device (e.g., a lens), one or more reflective optical device (e.g., a mirror), one or more diffractive optical devices (e.g., a grating), one or more dichroic optical devices (e.g., a dichroic filter or mirror), or the like. Although two sets of imaging optics 92 and 98 are shown in FIG. 6, in other examples, system 80 may include a single set of imaging optics or more than two sets of imaging optics.

Occulting device 94 is positioned within the optical train between first imaging optics 92 and second imaging optics 96. In other example, occulting device 94 may be positioned between imaging device 98 and imaging optics 96 or after before imaging optics 92. In some examples, occulting device 94 is positioned as the optical component nearest imaging device. This effectively results in removal of the portion of the image which occulting device 94 blocks. In other examples, occulting device 94 is positioned at another position within the optical train 80 where the image of component 22 resolves. Imaging optics 96 then may be configured to image occulting device 94 onto imaging device 98.

As shown in FIG. 6, in some examples, at least a portion of optical system 80 is coaxial with the axis at which energy delivery device 16 outputs energy 34. For example, at least a portion of second imaging optics 92 (e.g., the portion at which thermal emissions 104 is incident upon second imaging optics 92) may be coaxial with the axis at which energy delivery device 16 outputs energy 34. This may reduce image manipulation that otherwise may be applied to the resulting image to correct for geometry of component 22, angular offset of optical system 80 relative to energy delivery device 16, shadowing due to the angular offset, interference, or the like. In other examples, optical system 80 (e.g., the portion at which thermal emissions 104 are incident upon second imaging optics 92) may not be coaxial with the axis at which energy delivery device 16 outputs energy 34, and computing device 12 (FIG. 1) or another computing device may manipulate the resulting image to compensate for geometry of component 22, angular offset of optical system 80 relative to energy delivery device 16, shadowing due to the angular offset, interference, or the like.

FIG. 6 also illustrates energy delivery device 16 outputting energy 34, which is incident upon component 22 and results in formation of melt pool 32. Surrounding melt pool is a cooling zone 102, in which temperature gradients from the temperature of melt pool 32 to ambient temperature are present. As shown in FIG. 6, melt pool 32 and cooling zone 102 emit thermal emissions 104 (e.g., thermal radiation), which travel through optical system 80 to imaging device 98, which images the thermal emissions 104. Occulting device 94 occults (e.g., reduces the intensity of or substantially eliminates) thermal emissions 104 from a selected region, e.g., a region corresponding to energy 34 and at least a portion of melt pool 32. This may allow imaging device 98 to more effectively image relatively lower intensity thermal emissions from at or near the edge of melt pool 32 and within cooling zone 102. This may enable more accurate measurement of temperatures within the cooling zone 102, and heat flow within cooling zone 102.

Returning to FIG. 5, system 10 also includes melt pool monitor (“MP monitor”) 15. Melt pool monitor 15 may include a sensor for monitoring a characteristic of melt pool 32. The monitored characteristic may be indicative of a temperature of melt pool 32. For example, the sensor may include an imaging system, such as a visual or thermal camera, e.g., camera to visible light or infrared (IR) radiation. A visible light camera may monitor the geometry of the melt pool, e.g., a width, diameter, shape, or the like. A thermal (or IR) camera may be used to detect the size, temperature, or both of the melt pool. In some examples, a thermal camera may be used to detect the temperature of the melt pool at multiple positions within the melt pool, such as a leading edge, a center, and a trailing edge of the melt pool. In some examples, the imaging system may include a relatively high-speed camera capable of capturing image data at a rate of tens or hundreds of frames per second or more, which may facilitate real-time detection of the characteristic of the melt pool. In some examples, MP monitor 15 may capture data at a sequence of particular points in time including a first point in time, a second point in time, etc. In some examples, data from melt pool monitor 15 may be analyzed by computing device 12 to determine a position of melt pool 32 on build surface 28. For example, computing device 12 may determine a center point of melt pool 32.

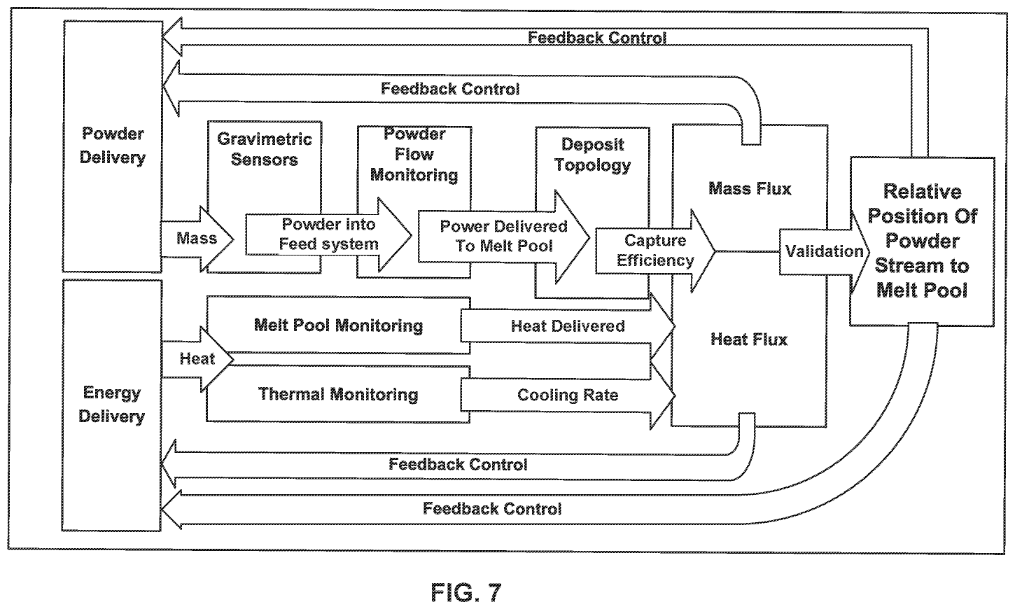

FIG. 7 is a process flow diagram illustrating an additive manufacturing monitor and control technique. The technique of FIG. 7 may be implemented by system 10 of FIGS. 1 and 5 and will be described with concurrent reference to FIGS. 1 and 5. However, it will be appreciated that system 10 may perform other techniques and the technique of FIG. 7 may be performed by other systems. For example, system 100 of FIG. 2 may perform the described technique.

One or more computing devices 12 may be configured to control a powder feed rate output by powder source 42 (see top left of FIG. 7). For instance, one or more computing devices 12 may be configured to control an agitator of powder source 42, a gas flow rate of gas flowing through powder source 42, a position of one or more valves within flow path 46, or the like to control a powder feed rate output by powder source 42.

One or more computing devices 12 may be configured to receive data from one or more mass flow monitoring sensors, including PFMS 18, powder flow mass sensor 44, and/or topology sensor 48. Data received from powder flow mass sensor 44 indicates a mass flow of powder from powder source 42 to powder delivery device. Data from PFMS 18 indicates a mass flow of powder in powder stream 30 between powder delivery device 14 to adjacent melt pool 32. Data from topology sensor 48 indicates powder mass captured by melt pool 32 and added to component 22.

One or more computing devices 12 may calculate one or more mass flow-related metrics based on the data received from PFMS 18, powder flow mass sensor 44, and/or topology sensor 48. For example, one or more computing devices 12 may determine a capture efficiency by determining a fraction or percentage of powder from powder stream 30 that is captured by melt pool 32 and added to component 22, e.g., by dividing the powder mass captured by melt pool 32, as determined based on data from topology sensor, into the mass flow determined based on data received from PFMS 18.

Further, one or more computing devices 12 may determine an overall mass flux using the data received from PFMS 18, powder flow mass sensor 44, and/or topology sensor 48. One or more computing devices 12 then may use the overall mass flux as an input to the control algorithm used to control the powder feed rate output by powder source 42 (see top left of FIG. 7). Additionally, one or more computing devices 12 may determine the position of powder stream 30, either absolutely within system 10 or relatively with respect to a deposition head.

Similarly, one or more computing devices 12 may be configured to control energy energy delivery device 16 to deliver energy 34 to first layer 24 to establish a given heat input (see bottom left of FIG. 7). For example, one or more computing device 12 may control one or more operating parameters of energy delivery device 16, such as by maintaining or adjusting an intensity, a pulse rate, a pulse width, or the like; one or more positional parameters related to energy delivery device 16, such as dwell time at a location, a movement rate relative to first layer 24, an overlap between adjacent passes of energy 34 across first layer 24, a pause time between adjacent passes of energy 34 across first layer 24, or the like to control heat input to system 10 (e.g., to melt pool 32 and component 22). The positional adjustment may be made to maintain or adjust a relative position of powder stream 30 to melt pool 32.

One or more computing devices 12 may be configured to receive data captured by one or more thermal sensors, such as optical system 80 and/or melt pool monitor 15. One or more computing devices may determine a cooling rate and associated heat from using data from optical system 80 and may determine a heat input into component using a size and/or temperature of melt pool 32 as observed by melt pool monitor 15. In some examples, one or more computing devices 12 may be configured to capture data from melt pool monitor 15, and may analyze the captured data to determine a position of a center point of melt pool 32.

In some examples, one or more computing devices 12 may, on the basis of the determined positions of powder stream 30 and melt pool 32, determine the relative position of powder stream 30 to melt pool 32. The determination of the relative position of powder stream 30 to melt pool 32 may be performed as a validation step on operation of system 10 to prevent overbuild or underbuild, or other deleterious effects of improper alignment of powder delivery device 14 and energy delivery device 16. With concurrent reference to FIGS. 1 and 2, in some cases, the powder delivery device and energy delivery device may be parts of deposition head 54. In such cases, computing device 12, to determine the relative position of powder stream 30 to melt pool 32, computing device 12 may compare the position of powder stream central axis L to a center point of melt pool 32. Further, computing device 12 may control the relative position of powder stream 30 to melt pool 32. For example, computing device 12 may determine that a distance between central axis L and the center point melt pool 32 exceeds a threshold distance, and adjust the position of powder delivery device 14 and/or energy delivery device 16 to decrease the distance between central axis L of powder stream 30 to melt pool 32 such that the distance falls within a threshold distance. In some examples, computing device 12 may adjust the position of the powder delivery device or the position of the energy delivery device such that central axis L passes through, or intersects, a center point of melt pool 32. In some examples, the center point of melt pool 32 may be a point on the surface of melt pool 32 which is the maximum distance from any edge of melt pool 32.

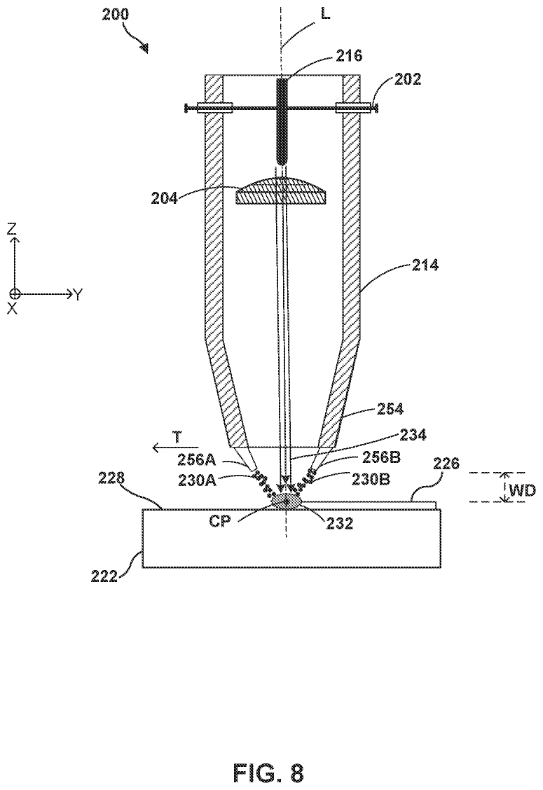

In some examples, as described above, computing device 12 may determine a capture efficiency of powder in powder stream 30 by melt pool 32. In some examples, computing device 12 may control the relative position of powder stream 30 to melt pool 32 to increase (e.g., maximize) the capture efficiency. While is some cases the capture efficiency may be maximized where powder stream central axis L intersects the center point of the melt pool, this is not always the case, as will be further described with respect to FIGS. 8-11.

FIGS. 8-11 are conceptual and schematic diagram illustrating a portion of additive manufacturing system 200. System 200 may be an example of system 10 of FIGS. 1 and 5 or system 100 of FIG. 2 System 200 includes deposition head 254, which includes both powder delivery device 214 and energy delivery device 216. Several additional components, including one or more computing devices, cameras, and sensors as described above with respect to system 10 and system 100 are not illustrated in FIGS. 8-11 for clarity. Components not illustrated in FIGS. 8-11 are described with respect to system 10 of FIGS. 1 and 5.

Deposition head 254 includes energy delivery device 216, which may generate and/or delivery energy 234 to build surface 228 of component 222 to form melt pool 232. Deposition head 254 includes powder delivery device 214, which directs powder stream 230 to the melt pool. Powder in powder stream 230, at least some of which may be at least partially melted by energy 234 while in flight across working distance WD, is captured by melt pool 232, and solidifies to form layer 226 on component 222 during the additive manufacturing process. Computing device 12 may cause deposition head 254 to travel along a toolpath, indicated by arrow T in FIGS. 8-11, and the relative position of powder stream 230 to melt pool 232 may be maintained as deposition head 254 travels along toolpath T to deposit layer 226.

Deposition head 254 houses energy delivery device 216, which in the illustrated example is a laser. Energy delivery device 216 may reside in a cavity within deposition head 254, and may be supported by one or more adjustable support members 202. In operation, computing device 12 may control adjustable support members 202 in one or more of the X, Y, or Z directions, via, for example, an electrical connection. Computing device 12 may actuate adjustable support members 202 to adjust the position of energy delivery device 216 within deposition head 254. In this way, computing device 12 may control the position of melt pool 232 on build surface 228. In some examples, energy delivery device 216 may include galvanometer 204, which may include a plurality of mirrors and/or lenses configured to position and shape energy 234 into a beam. Adjustment of galvanometer 204 by computing device 12 may allow for selective tailoring of the position, frequency, polarity, and/or other aspects of energy 234 delivered to build surface 228 to form melt pool 232.

Powder travels from powder source 42 through powder delivery device 214 via channels formed in the walls of deposition head 254, and exits delivery nozzles 256A, 256B (collectively, “delivery nozzles 256”) as powder stream 230A, 230B (collectively, “powder stream 230”). Powder stream 230 defines powder stream central axis L as described above. Powder stream 230 traverses working distance WD between delivery nozzles 256 and build surface 228. Delivery nozzles 256 may be controlled independent of energy delivery device 216 by computing device 12 to adjust the position of powder stream 230 relative to melt pool 232. For example, delivery nozzles 256 may direct powder stream 230 towards melt pool 232 at an angle, and the angle may be adjusted by computing device 12. Similarly, the orifice size or position of delivery nozzles 256 may be adjusted by computing device 12, in examples where powder delivery device 214 allows for these parameters to be adjusted in situ.

Computing device 12 may determine, based on captured data that is representative of the position of powder stream 230 and captured data that is representative of melt pool 232, the relative position of powder stream 230 to melt pool 232. For example, in computing device 12 may determine central axis L of powder stream 230, and may also determine center point CP of melt pool 232. In some examples, computing device 12 may compare the position of powder stream 230 to melt pool 232 by determining a displacement distance D and direction vector between center point CP of melt pool 232 and the point at which powder stream central axis L intersects build surface 228. Computing device 12 may determine whether displacement distance D exceeds a threshold distance (e.g., less than about 0.1 millimeter, less than about 1 millimeter, less than about 2 millimeters, or the like).

Responsive to determining that displacement distance D does not exceed a threshold distance, computing device 12 may control deposition head 254 to maintain the relative position of powder stream 230 to melt pool 232 throughout a portion of an additive manufacturing process. Responsive to determining that displacement distance D exceeds a threshold distance, computing device 12 may output a signal indicative of system 200 being out of alignment, may stop the deposition of layer 226, or may adjust the position of powder delivery device 214 and/or energy delivery device 216 to reduce displacement distance D such that displacement distance D does not exceed the displacement distance threshold.

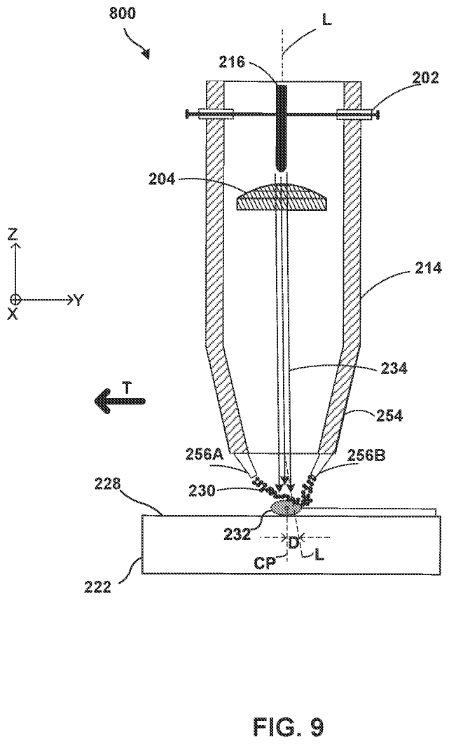

FIG. 8 illustrates system 10 in a normal operation. In some examples, system 10 may be set such that powder stream central axis L of powder stream 230 intersects melt pool center point CP of melt pool 232. Computing device 12 may maintain the relative position of powder stream 230 to melt pool 232 as deposition head 254 travels along toolpath T to deposit layer 226. However, some operations may cause dealignment of the relative position of powder stream 230 to melt pool 232. As illustrated in FIG. 9, increased velocity of deposition head 254 along toolpath T (indicated by the larger arrow in FIG. 8 compared to FIG. 8) may cause powder in powder stream 230 to drag behind deposition head 254 when traveling across working distance WD, such that powder stream central axis L is displaced from melt pool center point CP by displacement distance D at build surface 228. The forces of gravity may have a similar influence, because the force of gravity may cause powder stream 30 to drift off-course where powder stream 230 is directed toward melt pool 232 in a direction that is not parallel to the gravitational force. Other causes of displacement distance D are also considered.

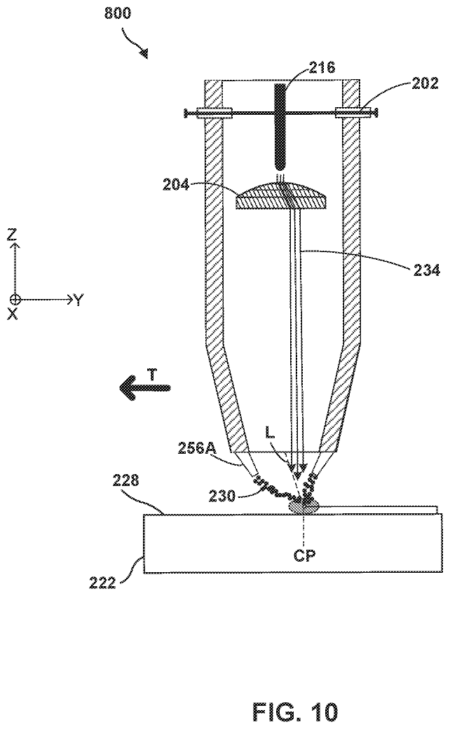

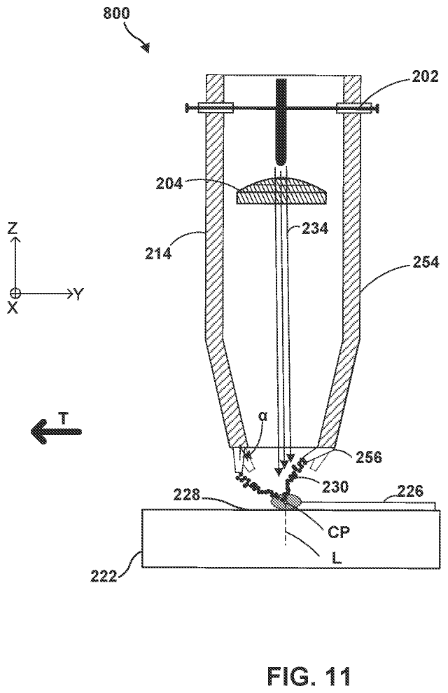

The displacement between powder stream central axis L may be deleterious to the resulting component 222. For example, techniques which are performed where displacement distance D is not controlled may result in underbuild and/or overbuild in portions of layer 226. System 200 may be configured to address this problem by causing, via computing device 12, adjustment of the relative position of powder stream 230 to melt pool 232. Adjustment of the relative position of powder stream 230 to melt pool 232 may be accomplished by adjusting, via computing device 12, the position of energy delivery device 216 (FIG. 10) and/or adjusting the position of powder delivery device 214 (FIG. 11). However, in some cases, it may be found that distance D imparts desirable impacts to the additive manufacturing process or resulting component (e.g., increased capture efficiency, reduced spatter from powder entering the melt pool 232, desired microstructure or porosity of finished component 222, or the like). In such cases, computing device 12 may control the relative position of powder stream 230 to melt pool 232 such that displacement distance D is controlled (e.g., maintained) throughout at least a portion of the additive-manufacturing process.

FIG. 10 illustrates an example alignment technique where computing device 12 controls the relative position of powder stream 230 to melt pool 232 by adjustment of the position of energy delivery device 216. In this example, computing device 212 causes melt pool 232 to move relative to deposition head 254 as it travels along toolpath T by adjustment of galvanometer 204. Galvanometer 204 includes a plurality of mirrors and/or lenses, which computing device 12 may control to deflect energy 234 off the path energy 234 was generated on by the laser, such the energy 234 impinges on a different location on build surface 228 than the position of FIG. 8. Thus, melt pool 232 is formed at a different location relative to powder delivery device 214 and the other components of deposition head 254. Although illustrated as adjusted solely by control of galvanometer 204, it is understood that the position of melt pool 232 may also be adjusted by modification of adjustable support members 202 by computing device 12. In some examples, as illustrated, computing device 12 may adjust the position of melt pool 232 such the displacement distance D is decreased (e.g., eliminated). Thus, system 10 may be configured to account for and control displacement distance D by modification of the relative position of powder stream 230 to melt pool 232 to realign system 10.

FIG. 11 illustrates an example alignment technique where computing device 12 controls the relative position of powder stream 230 to melt pool 232 by adjustment of the position of powder delivery device 214. For example, after determining that the control technique of FIG. 9 results in a capture efficiency that does not meet a threshold capture efficiency for continuing the build under the current settings, computing device 12 may adjust the angle delivery nozzles 256 by angle a. Adjustment of the position of delivery nozzles 256 may cause powder stream central axis L to intersect melt pool center point CP. In some examples, adjustment of the position of powder delivery device 214 by computing device 12 may control the relative position of powder stream 230 to melt pool 232 to increase and/or optimize the capture efficiency.

The control techniques illustrated in FIGS. 10 and 11 may be used together or separately during an additive manufacturing process to realign or maintain desired control of the relative position of powder stream 230 to melt pool 232. Further, the techniques illustrated by FIGS. 10 and 11 may be employed in various degrees during different portions of the manufacture of component 22. For example, computing device 12 may control delivery nozzles 256 such that angle a has a greater magnitude when deposition is occurring substantially orthogonal to the gravitational force than when deposition is occurring substantially parallel to the gravitational force. As another example, computing device 12 may cause melt pool 232 to move further from a default position when deposition head 254 is traveling faster along toolpath T than when deposition head 254 is moving along toolpath T at a slower rate.

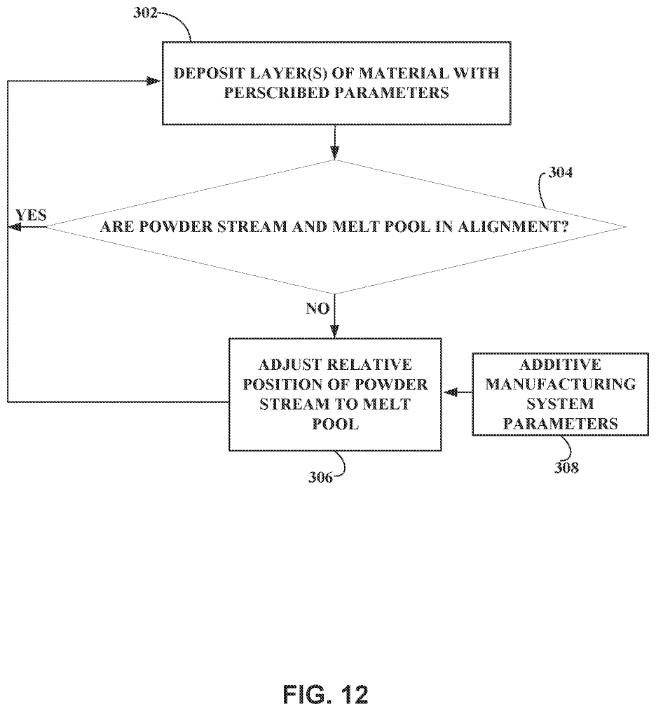

FIG. 12 is a flow diagram illustrating an example technique for validating alignment of a powder stream and melt pool according to the present disclosure. The illustrated technique may be performed by system 10 of FIGS. 1 and 5, and is primarily described as performed by system 10, but other systems may be used to perform the described techniques, such as system 100 of FIG. 2 or system 200 of FIGS. 8-11. Furthermore, system 10 and system 100 may be used to perform other techniques.

The technique of FIG. 12 includes controlling, by computing device 12 of system 10, deposition of layer 26 on component 22 by additive manufacturing system 10 (302). To deposit layer 26, computing device 12 causes energy delivery device 16 to deliver energy 34 to form melt pool 32 on build surface 28 of component 22. Computing device 12 then causes powder delivery device 14 to direct powder stream 30 to melt pool 32. Powder in powder stream 30 is captured by melt pool 32, and the melt pool and captured powder solidify to form layer 26.

Computing device 12 may determine whether powder stream 30 and melt pool 32 are in alignment (304). Computing device 12 may store instruction to make the alignment determination base on build progress (e.g., every layer 26, every completion of a toolpath pattern, or the like) or based on a time increment (e.g., every second, every minute, or the like). In some examples, to determine the position of powder stream 30, computing device 12 may determine a position of central axis L of powder stream 30 using data captured by PFMS 18. Similarly, computing device 12 may determine a position of melt pool 32 using data captured by MP monitor 15 and/or optical system 80. MP monitor 15, optical system 80, and/or PFMS 18 may use a combination of coaxial and off-axis imaging devices such as cameras.

With concurrent reference to FIGS. 1, 5, and 8-11, In some examples, to determine the position of melt pool 32, computing device 12 may determine a position of melt pool center point CP. To determine the relative position of powder stream 30 to melt pool 32, computing device 12 may compare the position of central axis L of powder stream 30 to the position of center point CP of melt pool 32. Responsive to determining that displacement distance D does not exceed a threshold (“YES” path in FIG. 12) and/or that the capture efficiency calculated based on date from mass sensor 44 and topology sensor 48 meets a threshold capture efficiency, computing device 12 may cause system 10 to continue the build, and may continue to validate the alignment of powder stream 30 to melt pool 32 to account for changing manufacturing settings or conditions.

Responsive to determining that displacement distance D exceeds a threshold displacement distance and/or that the calculated capture efficiency does not meet a threshold capture efficiency, computing device 12 may adjust the relative position of powder stream 30 to melt pool 32 (306). In some examples, computing device 12 may adjust the relative position of powder stream 30 to melt pool 32 by adjusting the position at least one of powder delivery device 14 or energy delivery device 16.

In some examples, computing device 12 may receive additional additive manufacturing system parameters and settings as inputs to determine whether, where, and by what magnitude to adjust the position of powder delivery device 14 and energy delivery device 16. Such additional parameters may include, but are not limited to, at least one of a powder size distribution of powder in powder stream 30, a beam shape of energy beam 34, a melt pool shape, size, or depth of melt pool 32, a powder feed mass flow rat from powder source 42 via mass sensor 44, a process gas flow rate, direction, and/or velocity, or the like. In some examples computing device 12 may execute a machine learning algorithm. The machine learning algorithm may be data generated by the determined capture efficiency and the relative position of the powder stream to the melt pool, and may be trained on any or all of the data from the additional parameters or setting of system 10. Process gases, as described herein, include powder carrier gases, center purge gases, coverage gases, or other gas flows that modify the shape or location of powder stream 30.

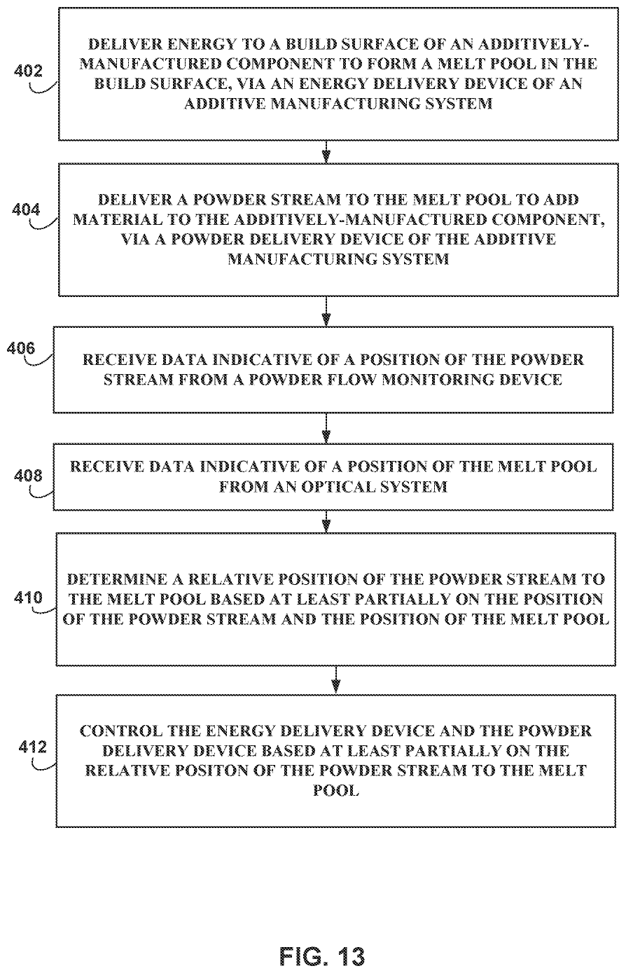

FIG. 13 is a flow diagram illustrating an example technique for controlling alignment of the relative position of a powder stream to a melt pool according to the present disclosure. The illustrated technique may be performed by system 10 of FIGS. 1 and 5, and is primarily described as performed by system 10, but other systems may be used to perform the described techniques, such as system 100 of FIG. 2 or system 200 of FIGS. 8-11. Furthermore, system 10 and system 100 may be used to perform other techniques.

Computing device 12 may cause energy delivery device 16 to deliver energy 34 to build surface 28 of additively-manufactured component 22 to form melt pool 32 in build surface 28 of component 22 (402). Component 22 may, in some examples, be a gas turbine engine component. In some examples, component 22 may be define a complex geometry not defined by rectilinear polygons. In some cases, energy delivery device may be a laser. Example laser sources include a CO laser, a CO₂ laser, a Nd:YAG laser, or the like. In some examples, energy delivery device 16 may both generate and deliver energy 34. In some examples, energy 34 may be selected to provide energy with a predetermined wavelength or wavelength spectrum that may be absorbed by component 22 and/or the powder to be added to component 22 during the additive manufacturing technique.

Computing device 12 may cause powder delivery device 14 to deliver powder stream 30 to melt pool 32 to add material to component 22 (404). In some examples, powder stream 30 may be powder entrained in a carrier gas or gases. The powder may include a metal or alloy, such that additively-manufactured component 22 includes a metal or an alloy. In some examples, powder delivery device 14 and energy delivery device 16 may be parts of a common deposition head 54. Deposition head 54 may travel along toolpath T to deposit layer 26 of material on a component during an additive manufacturing process.

Computing device 12 may receive from powder flow monitoring system (PFMS) 18, data indicative of a position of powder stream 30 (406). PFMS 18 may include one or more cameras which capture image data, and computing device 12 may analyze the captured image data to determine the position of powder stream 30. In some examples, computing device 12 may determine a position of central axis L of powder stream 30, and may map the position of central axis L relative to deposition head 54 (FIG. 2), or absolutely within system 100 (FIG. 2).

Computing device may receive data indicative of a position of melt pool 32 from optical system 80 (408). Optical system 80 may include one or more cameras which capture image data, and computing device 12 may analyze the captured image data to determine the position of melt pool 32. For example, optical system 80 may include a camera disposed on an axis of energy delivery device 16, and a second camera displaced from the axis of energy delivery device 16 positioned to capture data indicative of the relative position of powder stream 30 to melt pool 32. In some examples, to determine the position of melt pool 32, computing device 12 may determine a position of center point CP of melt pool 32.

Computing device 12 may determine, based on the position of powder stream 30 and the position of melt pool 32, a relative position of powder stream 30 to melt pool (410). In some examples, to determine the relative position of powder stream 30 to melt pool 32, computing device 12 may compare the position of central axis L of powder stream 30 to the position of center point CP of melt pool 32. In some examples, system 10 may additively manufacture component 22 while component 22 is supported by stage 20. Computing device 12 may adjust the relative position of powder stream 30 to melt pool 32 while component 22 is being additively-manufactured and mechanically supported by stage 20.

Computing device 12 may control energy delivery device 16 and powder delivery device 14 based at least partially on the relative position powder stream 30 to melt pool 32 (412). In some examples, computing device 12 may determine whether displacement distance D between central axis L of powder stream 30 and center point CP of melt pool 32 exceeds a threshold distance. Responsive to determining that displacement distance D exceeds a threshold displacement distance D, computing device 12 may adjust relative position of central axis L of powder stream 30 or center point CP of melt pool 32 to decrease displacement distance D such that displacement distance D falls within the threshold distance. To adjust the position of powder stream 30, computing device 12 may adjust the position of powder delivery device 14, for example by manipulation of the angle or position of one or more delivery nozzles 56. Similarly, to adjust the position of melt pool 32, computing device 12 may adjust the position of delivery device 16, for example by manipulation of the position of one or more adjustable support members 202 or galvanometer 204. In some examples, computing device 12 may adjust at least one of the positions of energy delivery device 16 or powder delivery device 14 such that central axis L of powder stream 30 intersects center point CP of melt pool 32.

In some examples, computing device 12 may determine a capture efficiency of powder in the powder stream 30 by melt pool 32. Based on the determined capture efficiency, computing device 12 may determine an adjustment to the position of one or both of powder delivery device 14 and/or energy delivery device 16. Computing device 12 may control, based on the determined adjustment, powder delivery device 14 and/or energy delivery device 16. Computing device 12 may, determine the adjustment to the position of energy delivery device 16 and/or powder delivery device 14 using a machine learning model that takes the determined captured efficiency as an input. Computing device 12 may further determine a plurality of additional parameters of the additive manufacturing system, and control energy delivery device 16 or powder delivery device 14 based at least partially on the determined additional parameters. Without limitation, the plurality of additional parameters may include a powder size distribution, a beam shape, a melt pool size, a melt pool shape, a powder feed rate, a powder feed mass flow rate, a gas carrier flow rate, a working distance, or the like. For example, one or more of the determined additional parameters may be input into the machine learning model. In some examples, computing device 12 may output, for display at a display device, a graphical representation of the relative position of powder stream 30 to melt pool 32.

The techniques described in this disclosure may be implemented, at least in part, in hardware, software, firmware, or any combination thereof. For example, various aspects of the described techniques may be implemented within one or more processors, including one or more microprocessors, digital signal processors (DSPs), application specific integrated circuits (ASICs), field programmable gate arrays (FPGAs), or any other equivalent integrated or discrete logic circuitry, as well as any combinations of such components. The term “processor” or “processing circuitry” may generally refer to any of the foregoing logic circuitry, alone or in combination with other logic circuitry, or any other equivalent circuitry. A control unit including hardware may also perform one or more of the techniques of this disclosure.

Such hardware, software, and firmware may be implemented within the same device or within separate devices to support the various techniques described in this disclosure. In addition, any of the described units, modules or components may be implemented together or separately as discrete but interoperable logic devices. Depiction of different features as modules or units is intended to highlight different functional aspects and does not necessarily imply that such modules or units must be realized by separate hardware, firmware, or software components. Rather, functionality associated with one or more modules or units may be performed by separate hardware, firmware, or software components, or integrated within common or separate hardware, firmware, or software components.

The techniques described in this disclosure may also be embodied or encoded in an article of manufacture including a computer-readable storage medium encoded with instructions. Instructions embedded or encoded in an article of manufacture including a computer-readable storage medium encoded, may cause one or more programmable processors, or other processors, to implement one or more of the techniques described herein, such as when instructions included or encoded in the computer-readable storage medium are executed by the one or more processors. Computer readable storage media may include random access memory (RAM), read only memory (ROM), programmable read only memory (PROM), erasable programmable read only memory (EPROM), electronically erasable programmable read only memory (EEPROM), flash memory, a hard disk, a compact disc ROM (CD-ROM), a floppy disk, a cassette, magnetic media, optical media, or other computer readable media. In some examples, an article of manufacture may include one or more computer-readable storage media.

In some examples, a computer-readable storage medium may include a non-transitory medium. The term “non-transitory” may indicate that the storage medium is not embodied in a carrier wave or a propagated signal. In certain examples, a non-transitory storage medium may store data that can, over time, change (e.g., in RAM or cache).

Various examples have been described. These and other examples are within the scope of the following examples and claims.

Example 1: An additive manufacturing system includes an energy delivery device configured to deliver energy to a build surface of an additively-manufactured component to form a melt pool in the build surface of the component; a powder delivery device configured to direct a powder stream toward the melt pool; a powder flow monitoring system configured to observe the powder stream; and an optical system configured to observe the melt pool; a computing device configured to: receive, from the powder flow monitoring system, data indicative of a position of the powder stream from the powder flow monitoring system; receive, from the optical system, data indicative of a position of the melt pool; determine, based on the position of the powder stream and the position of the melt pool, a relative position of the powder stream to the melt pool; and control, based on the determined relative position of the powder stream to the melt pool, one or both of the powder delivery device and the energy delivery device.

Example 2: The additive manufacturing system of example 1, wherein: to determine the position of the powder stream, the computing device is configured to determine a position of a central axis of the powder stream; to determine the position of the melt pool, the computing device is configured to determine a position of a center point of the melt pool; and to determine the relative position of the powder stream to the melt pool, the computing device is configured to compare the position of central axis of the powder stream to the position of the center point of the melt pool.

Example 3: The additive manufacturing system of example 2, wherein the computing device is configured to determine whether a distance between the central axis of the powder stream and the center point of the melt pool exceeds a threshold distance, and responsive to determining that a distance between the central axis of the powder stream and the center point of the melt pool exceeds a threshold displacement distance, adjust relative position of the central axis of the powder stream or the center point of the melt pool to decrease the distance between the central axis of the powder stream and the center point of the melt pool to fall to fall within a threshold displacement distance.

Example 4: The additive manufacturing system of any of examples 2 and 3, wherein the computing device is configured to adjust at least one of the positions of the energy delivery device or the powder delivery device such that the central axis of the powder stream intersects the center point of the melt pool.

Example 5: The additive manufacturing system of any of examples 1 through 4,wherein, to control the powder delivery device and the energy delivery device, the computing device is configured to adjust the relative position of the powder stream to the melt pool by adjusting the position at least one of the powder delivery device or the energy delivery device.

Example 6: The additive manufacturing system of example 5, wherein the computing device is configured to: determine a capture efficiency of powder in the powder stream by the melt pool, determine, based on the determined capture efficiency, an adjustment to one or both of the position of the powder delivery device or the energy delivery device, and control, based on the determined adjustment, the powder delivery device or the energy delivery device.

Example 7: The additive manufacturing system of example 6, wherein the computing device is configured to determine, using a machine learning model that takes the determined captured efficiency as an input, the adjustment to one or both of the position of the powder delivery device or the energy delivery device.

Example 8: The additive manufacturing system of any of examples 1 through 7, wherein the powder delivery device and the energy delivery device are parts of a deposition head.

Example 9: The additive manufacturing system of example 8, wherein: the energy delivery device comprises one or more galvanometers; the energy delivery device is a laser; and the position of the energy delivery device is adjustable by manipulation of the one or more galvanometers.

Example 10: The additive manufacturing system of any of examples 8 and 9, wherein: the powder delivery device comprises one or more delivery nozzles, and to control the powder delivery device, the computing device is configured to control the angle or the position of the of the one or more delivery nozzles.

Example 11: The additive manufacturing system of any of examples 1 through 10, wherein: the powder delivery device and the energy delivery device are parts of a deposition head, the central axis of the powder stream is defined by a first point equidistant from a plurality of delivery nozzles at a downstream end of the deposition head and a second point at which powder from each of the plurality of deposition nozzles converges, the deposition head is configured to travel along a toolpath to deposit a layer of material on a component during an additive manufacturing process, the powder stream central axis is displaced along the build surface by a displacement distance from the center point of the melt pool, the computing device is configured to determine the displacement distance, and control the relative position of the powder stream to the melt pool based on the determined displacement distance.

Example 12: The additive manufacturing system of any of examples 1 through 11, wherein the computing device is further configured to determine a plurality of additional parameters of the additive manufacturing system; wherein the plurality of additional parameters include at least one of a powder size distribution, a beam shape, a melt pool size, a melt pool shape, a powder feed rate, a powder feed mass flow rate, a process gas flow rate, or flow velocity, or flow direction, and control the energy delivery device or the powder delivery device based at least partially on the determined additional parameters.

Example 13: The additive manufacturing system of any of examples 1 through 12,further comprising the additively manufactured component, wherein the additively manufactured component is a gas turbine engine component.

Example 14: The additive manufacturing system of any of examples 1 through 13, wherein the computing device is configured to output, for display at a display device, a graphical representation of the relative position of the powder stream to the melt pool.

Example 15: The additive manufacturing system of any of examples 1 through 14, wherein the optical system includes: a camera disposed on an axis of the energy delivery device, and a second camera displaced from the axis of the energy delivery device positioned to capture data indicative of the relative position of the powder stream to the melt pool, wherein the computing device is configured to adjust the relative position of the powder stream to the melt pool based at least partially on the data captured by the second camera.

Example 16: The additive manufacturing system of any of examples 1 through 15, wherein the additive manufacturing system is configured to additively-manufacture the component layer-by-layer while the component is mechanically supported by a stage, and wherein the computing device is configured to adjust the relative position of the powder stream to the melt pool while the component is being additively-manufactured and mechanically supported by the stage.

Example 17: A method includes delivering, via an energy delivery device, energy to a build surface of an additively-manufactured component to form a melt pool in the build surface of the component; delivering, via a powder delivery device, a powder stream to the melt pool to add material to the component; receiving, from a powder flow monitoring device, data indicative of a position of the powder stream; receiving, from an optical system, data indicative of a position of the melt pool; determining, via a computing device, based on the position of the powder stream and the position of the melt pool, a relative position of the powder stream to the melt pool; and controlling, via the computing device, one or both of the energy delivery device and the powder delivery device based at least partially on the relative position of powder stream to the melt pool.

Example 18: The method of example 17, wherein controlling comprises adjusting, via the computing device, based on the determined relative position of the powder stream and the melt pool, the position of the energy delivery device or the powder delivery device.

Example 19: The method of any of examples 17 through 18, further includes determining, via the computing device, a central axis of the powder stream to determine the position of the powder stream; determining, via the computing device, a center point of the melt pool to determine the position of the melt pool; and comparing, via the computing device, the central axis of the powder stream to the center point of the melt pool to determine the relative position of the powder stream to the melt pool.

Example 20: The method of example 19, further comprising determining, via the computing device, whether a distance between the central axis of the powder stream and the center point of the melt pool exceeds a threshold distance, and responsive to determining that a distance between the central axis of the powder stream and the center point of the melt pool exceeds a threshold distance, adjusting, via the computing device, the relative position of the central axis of the powder stream or the center point of the melt pool to decrease the distance between the central axis of the powder stream and the center point of the melt pool to fall to fall within a threshold distance.

Example 21: The method of any of examples 17 through 20, further includes

determining, via the computing device, a capture efficiency of powder in the powder stream by the melt pool, and adjusting, via the computing device, the relative position of the powder stream or the melt pool to increase the capture efficiency.

What is claimed is:

1. An additive manufacturing system comprising:
an energy delivery device configured to deliver energy to a build surface of an additively-manufactured component to form a melt pool in the build surface of the component;
a powder delivery device configured to direct a powder stream toward the melt pool;
a powder flow monitoring system configured to observe the powder stream; and
an optical system configured to observe the melt pool;
a computing device configured to:
receive, from the powder flow monitoring system, data indicative of a position of the powder stream from the powder flow monitoring system;
receive, from the optical system, data indicative of a position of the melt pool;
determine, based on the position of the powder stream and the position of the melt pool, a relative position of the powder stream to the melt pool; and
control, based on the determined relative position of the powder stream to the melt pool, one or both of the powder delivery device and the energy delivery device.

2. The additive manufacturing system of claim 1, wherein:
to determine the position of the powder stream, the computing device is configured to determine a position of a central axis of the powder stream;
to determine the position of the melt pool, the computing device is configured to determine a position of a center point of the melt pool; and
to determine the relative position of the powder stream to the melt pool, the computing device is configured to compare the position of central axis of the powder stream to the position of the center point of the melt pool.

3. The additive manufacturing system of claim 2, wherein the computing device is configured to determine whether a distance between the central axis of the powder stream and the center point of the melt pool exceeds a threshold distance, and
responsive to determining that a distance between the central axis of the powder stream and the center point of the melt pool exceeds a threshold displacement distance, adjust relative position of the central axis of the powder stream or the center point of the melt pool to decrease the distance between the central axis of the powder stream and the center point of the melt pool to fall to fall within a threshold displacement distance.

4. The additive manufacturing system of claim 2, wherein the computing device is configured to adjust at least one of the positions of the energy delivery device or the powder delivery device such that the central axis of the powder stream intersects the center point of the melt pool.

5. The additive manufacturing system of claim 1, wherein, to control the powder delivery device and the energy delivery device, the computing device is configured to adjust the relative position of the powder stream to the melt pool by adjusting the position at least one of the powder delivery device or the energy delivery device.

6. The additive manufacturing system of claim 5, wherein the computing device is configured to:
determine a capture efficiency of powder in the powder stream by the melt pool,
determine, based on the determined capture efficiency, an adjustment to one or both of the position of the powder delivery device or the energy delivery device, and
control, based on the determined adjustment, the powder delivery device or the energy delivery device.

7. The additive manufacturing system of claim 6, wherein the computing device is configured to determine, using a machine learning model that takes the determined captured efficiency as an input, the adjustment to one or both of the position of the powder delivery device or the energy delivery device.

8. The additive manufacturing system of claim 1, wherein the powder delivery device and the energy delivery device are parts of a deposition head.

9. The additive manufacturing system of claim 8, wherein:
the energy delivery device comprises one or more galvanometers;
the energy delivery device is a laser; and
the position of the energy delivery device is adjustable by manipulation of the one or more galvanometers.

10. The additive manufacturing system of claim 8, wherein:
the powder delivery device comprises one or more delivery nozzles, and
to control the powder delivery device, the computing device is configured to control the angle or the position of the of the one or more delivery nozzles.

11. The additive manufacturing system of claim 1, wherein:
the powder delivery device and the energy delivery device are parts of a deposition head,
the central axis of the powder stream is defined by a first point equidistant from a plurality of delivery nozzles at a downstream end of the deposition head and a second point at which powder from each of the plurality of deposition nozzles converges,
the deposition head is configured to travel along a toolpath to deposit a layer of material on a component during an additive manufacturing process,
the powder stream central axis is displaced along the build surface by a displacement distance from the center point of the melt pool,
the computing device is configured to determine the displacement distance, and control the relative position of the powder stream to the melt pool based on the determined displacement distance.

12. The additive manufacturing system of claim 1, wherein the computing device is further configured to determine a plurality of additional parameters of the additive manufacturing system;
wherein the plurality of additional parameters include at least one of a powder size distribution, a beam shape, a melt pool size, a melt pool shape, a powder feed rate, a powder feed mass flow rate, a process gas flow rate, or flow velocity, or flow direction, and
control the energy delivery device or the powder delivery device based at least partially on the determined additional parameters.

13. The additive manufacturing system of claim 1, further comprising the additively manufactured component, wherein the additively manufactured component is a gas turbine engine component.

14. The additive manufacturing system of claim 1, wherein the optical system includes:
a camera disposed on an axis of the energy delivery device, and
a second camera displaced from the axis of the energy delivery device positioned to capture data indicative of the relative position of the powder stream to the melt pool,
wherein the computing device is configured to adjust the relative position of the powder stream to the melt pool based at least partially on the data captured by the second camera.

15. The additive manufacturing system of claim 1, wherein the additive manufacturing system is configured to additively-manufacture the component layer-by-layer while the component is mechanically supported by a stage, and
wherein the computing device is configured to adjust the relative position of the powder stream to the melt pool while the component is being additively-manufactured and mechanically supported by the stage.

16. A method comprising:
delivering, via an energy delivery device, energy to a build surface of an additively-manufactured component to form a melt pool in the build surface of the component;
delivering, via a powder delivery device, a powder stream to the melt pool to add material to the component;
receiving, from a powder flow monitoring device, data indicative of a position of the powder stream;
receiving, from an optical system, data indicative of a position of the melt pool;
determining, via a computing device, based on the position of the powder stream and the position of the melt pool, a relative position of the powder stream to the melt pool; and
controlling, via the computing device, one or both of the energy delivery device and the powder delivery device based at least partially on the relative position of powder stream to the melt pool.

17. The method of claim 16, wherein controlling comprises adjusting, via the computing device, based on the determined relative position of the powder stream and the melt pool, the position of the energy delivery device or the powder delivery device.

18. The method of claim 16, further comprising:
determining, via the computing device, a central axis of the powder stream to determine the position of the powder stream;
determining, via the computing device, a center point of the melt pool to determine the position of the melt pool; and
comparing, via the computing device, the central axis of the powder stream to the center point of the melt pool to determine the relative position of the powder stream to the melt pool.

19. The method of claim 18, further comprising determining, via the computing device, whether a distance between the central axis of the powder stream and the center point of the melt pool exceeds a threshold distance, and
responsive to determining that a distance between the central axis of the powder stream and the center point of the melt pool exceeds a threshold distance, adjusting, via the computing device, the relative position of the central axis of the powder stream or the center point of the melt pool to decrease the distance between the central axis of the powder stream and the center point of the melt pool to fall to fall within a threshold distance.

20. The method of claim 16, further comprising:
determining, via the computing device, a capture efficiency of powder in the powder stream by the melt pool, and
adjusting, via the computing device, the relative position of the powder stream or the melt pool to increase the capture efficiency.
